(19) United States
(12) Patent Application Publication
(10) Pub. No.: US 2024/0392584 A1
(43) Pub. Date: Nov. 28, 2024

(54) SCAFFOLD DEVICE AND ASSEMBLY METHOD FOR SCAFFOLD DEVICE

(71) Applicant: BrandSafway Services LLC, Atlanta, GA (US)

(72) Inventor: Dai ONO, Tokyo (JP)

(21) Appl. No.: 18/612,761

(22) Filed: Mar. 21, 2024

Related U.S. Application Data
(63) Continuation of application No. PCT/JP2022/035453, filed on Sep. 22, 2022.

(30) Foreign Application Priority Data
Sep. 22, 2021 (JP) 2021-154863

(51) Int. Cl. E04G 3/22; E04G 5/00; E04G 5/08; E04G 7/02

(52) U.S. Cl. CPC E04G 3/22; E04G 5/007; E04G 5/08; E04G 7/02

(57) ABSTRACT

[Problem] An object of the present invention is to provide a scaffold device and a method of assembling the scaffold device, whereby it is possible to reduce the weight of the components that constitute the scaffold device, simplify assembly work, and shorten the time required for assembly.

[Resolution Means] Means for solving the problem is characterized in that the means is provided with a frame 6 having a pair of longitudinal beams 2, 2, a pair of transverse beams 3, 3, and four coupling members 5 disposed between each end portion of the longitudinal beam 2 and each end portion of the transverse beam 3 and rotatably connecting the longitudinal beam 2 and the transverse beam 3 on the same plane; two or more intermediate beams 7 spanning between the longitudinal beams 2, 2 at a predetermined interval; and a scaffolding plate 8 spanning between the longitudinal beams 2, 2 and supported by at least one of the intermediate beams 7, the number of scaffolding plates being one greater than the number of intermediate beams 7 installed.

### TECHNICAL FIELD

The present invention relates to a scaffold device and a method of assembling a scaffold device.

### BACKGROUND ART

A conventional scaffold device, for example, is suspended from a building or structure and is used in construction and maintenance work of a building or structure (for example, see Patent Literature 1).

Specifically, the scaffold device illustrated in Patent Literature 1 is provided with a frame having a pair of longitudinal beams, a pair of transverse beams, and four coupling members disposed between each end portion of the longitudinal beam and each end portion of the transverse beam and rotatably connecting the vertical beam and the horizontal beam in a horizontal direction; and a respective scaffolding plate spanning between each longitudinal beam and a central beam spanning a center between the pair of transverse beams.

Furthermore, in the scaffold device of Patent Literature 1, in a state where the base ends of each longitudinal beam for expansion are horizontally and rotatably connected to two adjoining, existing coupling members disposed at a back side of the existing frame in the depth direction, and, using the existing coupling members as a fulcrum, the longitudinal beams for expansion have been pulled in toward the transverse beam and folded, after attaching the coupling members for expansion to a tip of each longitudinal beam for expansion and spanning the transverse beams for expansion between the adjacent coupling members for expansion, the longitudinal beams for expansion are rotated horizontally so as to be disposed mutually parallel, enabling the frame for expansion to be connected consecutively to the existing frame. Also, spanning the central beam between the existing transverse beams and the transverse beams for expansion opposing in the depth direction of the frame for expansion and spanning the scaffolding plate between the central beam and each longitudinal beam for expansion makes it possible for the scaffold device of Patent Literature 1 to expand a floor plate area.

### PRIOR ART DOCUMENTS

### Patent Literature

Patent Literature 1: U.S. Pat. No. 5,820,848

### SUMMARY OF INVENTION

### Problem to be Solved by Invention

However, in a conventional scaffold device, the components that constitute the scaffold device are large or are formed of materials having a high mass per unit volume for ensuring the load that can be carried on the scaffold device (hereinafter referred to as “load capacity”), resulting in the weight of the components that constitute the scaffold device being heavy, and the work of assembling the scaffold device resulting in heavy labor for workers.

Thus, an object of the present invention is to provide a scaffold device, which is aimed at reducing the weight of the components that constitute the scaffold device, and a method of assembling the scaffold device whereby the assembly work is simplified.

### Means for Solving Problem

To achieve the foregoing object, the scaffold device of the present invention is characterized in that it is provided with a frame having a pair of longitudinal beams, a pair of transverse beams, and four coupling members disposed between each end portion of the longitudinal beam and each end portion of the transverse beam and rotatably connecting the longitudinal beam and the transverse beam on the same plane; two or more intermediate beams spanning between the longitudinal beams at a predetermined interval; and a scaffolding plate spanning between the longitudinal beams and supported by at least one of the intermediate beams, the number of scaffolding plates being one greater than the number of intermediate beams installed. According to this configuration, the number of scaffolding plates installed in the frame may be at least three or more, which makes it possible to further reduce the weight per scaffolding plate compared to when the number of scaffolding plates installed in the frame is two or fewer.

Furthermore, in the scaffold device of the present invention, the longitudinal beam and the transverse beam may have a beam body, and a respective connecting part connected detachably to both ends of the beam body in a lengthwise direction and capable of connecting the beam body to the coupling member. According to this configuration, when the beam body or the connecting part of the longitudinal beam or the transverse beam is damaged, only the damaged component needs to be detached and replaced, making maintenance of the scaffold device simple.

Furthermore, in the scaffold device of the present invention, the beam body may be formed of a material having a lower mass per unit volume than the connecting part, and the connecting part may be formed of a material having a higher rigidity than the beam body. According to this configuration, only the connecting part, which is subject to a large shear load during use, is formed of a highly rigid material, and the beam body, which is subject to a smaller load than the connecting part, is formed of a material having a smaller mass per unit volume than the connecting part; therefore, it is possible to reduce the weight of the longitudinal beam or the transverse beam while ensuring the rigidity of the scaffold device and without reducing the load capacity.

Furthermore, in the scaffold device of the present invention, the beam body has an upper chord member and a lower chord member, which are disposed opposing at the top and bottom and mutually parallel, and at least one bundle member and a plurality of a diagonal member, which span between the upper chord member and the lower chord member and connect the upper chord member to the lower chord member; and the upper chord member, the lower chord member, the bundle member, and the diagonal member may be mutually connected in a detachable form. According to this configuration, even if a component constituting the beam body is damaged or deformed due to aging or a load, only the damaged or deformed component needs to be detached and replaced, making maintenance of the scaffold device simple.

Furthermore, in the scaffold device of the present invention, the upper chord member has a flat plate-shaped scaffolding plate support portion extending along the beam body in an axial direction and supporting the scaffolding plate, and a pair of positioning pieces standing upward from an upper surface side of the scaffolding plate support portion and mutually opposing, and also restricting horizontal direction movement of the scaffolding plate supported by the scaffolding plate support portion; a bracket to which a suspension material for suspending the longitudinal beam or the transverse beam may be attached is connected between the positioning pieces in the scaffolding plate support portion; two scaffolding plates are placed clamping the positioning pieces with respect to the scaffolding plate support portion; and a width of the bracket may be narrower than the width between the two scaffolding plates. According to this configuration, even if the bracket is attached in advance to the longitudinal beam or the transverse beam during the assembly of scaffold device, the bracket will not constitute an obstruction when the scaffolding plate spans between the longitudinal beams. Therefore, the suspension material may be attached to the bracket immediately after all the scaffolding plates are installed on the frame, and the time during which the scaffold device is not suspended by the suspension material attached to the bracket may be shortened, thereby improving safety.

Furthermore, in the scaffold device of the present invention, in a state where a first mounting hole provided to the connecting part and an insertion hole provided to the coupling member are opposing, a fixing pin inserted into the first mounting hole and the insertion hole may cause the coupling member to be rotatably connected to the longitudinal beam or the transverse beam; and in a state where a second mounting hole provided to the connecting part and an anti-rotation groove provided at a perimeter of the coupling member are opposing, an anti-rotation pin inserted into the second mounting hole and the anti-rotation groove may cause the coupling member to be fixed to the longitudinal beam or the transverse beam in a non-rotatable state. According to this configuration, when the transverse beam spans between adjoining coupling members in the width direction, provided that at least one of the coupling members among at least one coupling member is rotatably connected to the longitudinal beam using only the fixing pin, one coupling member may be rotated inward to bring the coupling member closer to the scaffolding plate side. Therefore, when the worker places the transverse beam to span between the coupling members from over the scaffolding plate, the extent to which the worker leans out from above the scaffolding plate may be reduced, allowing the transverse beam to be placed to span between the coupling members in a safer manner.

Furthermore, in the scaffold device of the present invention, an upper end of the fixing pin and the anti-rotation pin is provided with two protrusions in a vertical line, protruding in a radial direction; and the two protrusions may be disposed facing a mutually intersecting direction when viewing the fixed pin and the anti-rotation pin from the axial direction. According to this configuration, when an upper side protrusion and a lower side protrusion are disposed vertically and in parallel, the upper ends of the fixing pin and the anti-rotation pin do not protrude from the scaffolding plate, even when the thickness of the scaffolding plate spanning between the longitudinal beams is further reduced to reduce the weight of the scaffolding plate, preventing the worker from tripping over the fixing pin and the anti-rotation pin.

Furthermore, in the scaffold device of the present invention, the coupling member has a pair of upper and lower plates disposed in parallel, and a linking part linking the plates; the plates have four insertion holes, which are respectively disposed at an equal interval on the same circumference and mutually opposing, and four anti-rotation grooves provided on a perimeter of the plates and at a position directly facing the insertion holes when viewed from the center of the plates; the connecting part has a pair of upper and lower connecting pieces protruding along the axial direction from each end portion of the beam body; each connecting piece has the respective mutually opposing first mounting holes, and the second mounting hole disposed at a position opposing the anti-rotation groove in a state where the first mounting hole is opposing at least one of the insertion holes; and the anti-rotation groove provided in the plate of a lower side may be formed shallower than the anti-rotation groove provided in the plate of an upper side. According to this configuration, the lower end of the anti-rotation pin is supported from the side by the lower side plate, even if it is subjected to a moment from the longitudinal beam or the transverse beam; therefore, the longitudinal beam or the transverse beam may be disposed horizontally.

Furthermore, the scaffold device of the present invention may also have an auxiliary beam supporting the scaffolding plate, spanning parallel to the respective longitudinal beam between the mutually opposing transverse beam and the intermediate beam and between the mutually opposing intermediate beams. According to this configuration, bending of the scaffolding plate may be prevented, and when installing the scaffolding plate, the scaffolding plate may be prevented from falling from a frame surrounded by the pair of longitudinal beams, the pair of transverse beams, and each intermediate beam.

Furthermore, in a method of assembling a scaffold device, the scaffold device is provided with a frame having a pair of longitudinal beams, a pair of transverse beams, and four coupling members disposed between each end portion of the longitudinal beam and each end portion of the transverse beam and rotatably connecting the longitudinal beam and the transverse beam on the same plane; two or more intermediate beams spanning between the longitudinal beams at a predetermined interval; and a scaffolding plate spanning between the longitudinal beams and supported by at least one of the intermediate beams, the number of scaffolding plates being one greater than the number of intermediate beams installed; wherein: the method of assembling the scaffold device is characterized by including: a step of respectively connecting an other end of a pair of longitudinal beams for expansion to which a coupling member for expansion is attached to one end to each coupling member disposed on one side of the frame; a step of spanning an intermediate beam for expansion between the pair of longitudinal beams for expansion, repeating a step of spanning a scaffolding board for expansion between the pair of longitudinal beams for expansion while supported by at least the spanned intermediate beam for expansion the same number of times as the number of intermediate beams to be installed in one frame, and spanning a transverse beam for expansion between the coupling members for expansion; and a step of spanning another scaffolding board for expansion between the pair of longitudinal beams for expansion while supported by at least the transverse beam for expansion. According to this configuration, the number of scaffolding plates installed in the frame may be at least three or more, which makes it possible for the width of the scaffolding plate to be narrower and to further reduce the weight per scaffolding plate compared to when the number of scaffolding plates installed in the frame is two or fewer.

Furthermore, in the scaffold device of the present invention, among the coupling members, two coupling members disposed at a front side in a depth direction of the frame are designated as front-side coupling members, and two coupling members disposed at a back side in the depth direction of the frame are designated as back-side coupling members; the coupling member has a left hole and a right hole, which are disposed in a line from left to right, and a front hole disposed further to the back side than the left hole and the right hole formed therein; the back-side coupling member is integrally connected to the back-side end of the longitudinal beam, and the front-side end thereof is provided with a first connecting part having a hole; the transverse beam has a beam body having a telescope part constituted by an outer cylinder and an inner cylinder slidably inserted into the outer cylinder, and a second connecting part provided at both ends of the beam body in a lengthwise direction and having a respective hole thereat; in a state where the hole of the first connecting part and the front hole of the front-side coupling member are opposing, a first linking pin inserted into the hole of the connecting part and the front hole of the front-side coupling member may rotatably connect the transverse beam in the horizontal direction to the front-side mounting member; and in a state where the respective hole of each second connecting part is opposing, among the two back-side connecting parts opposing in the width direction of the frame, the right hole of the back-side connecting part on a left side and the left hole of the back-side connecting part on a right side, a respective second linking pin inserted into the left hole, the right hole, and the hole of each second connecting part may rotatably connect each end portion of the transverse beam in the horizontal direction to each back-side coupling member. According to this configuration, the back coupling member is integrally connected to the back-side end of the longitudinal beam, eliminating the need for the worker to perform the work of connecting the back-side coupling member to each longitudinal beam when assembling the scaffold device. Therefore, the work of assembling the scaffold device is simplified and the time required for assembly of the scaffold device may be shortened.

Furthermore, in the scaffold device of the present invention, among the coupling members, two coupling members disposed at a front side in a depth direction of the frame are designated as front-side coupling members, and two of the coupling members disposed at a back side in the depth direction of the frame are designated as back-side coupling members; the coupling member has a left hole and a right hole, which are disposed in a line from left to right, and a front hole disposed further to the back side than the left hole and the right hole formed therein; the back-side coupling member is integrally connected to the back-side end of the longitudinal beam, and the front-side end thereof is provided with a first connecting part having a hole; both ends of the transverse beam in a lengthwise direction are provided with a second connecting part having a hole of a long length in a direction along the respective transverse beam in the axial direction; in a state where the hole of the first connecting part and the front hole of the front-side coupling member are opposing, a first linking pin inserted into the hole of the first connecting part and the front hole of the front-side coupling member rotatably connects the longitudinal beam in the horizontal direction to the front-side mounting member; in a state where the respective hole of each second connecting part is opposing, among the two back-side connecting parts opposing in the width direction of the frame, the right hole of the back-side connecting part on a left side and the left hole of the back-side connecting part on a right side, a respective second linking pin inserted into the left hole, the right hole, and the hole of each second connecting part rotatably connects each end portion of the transverse beam in the horizontal direction to each back-side coupling member; and the second linking pin may be slidable along the hole of the second connecting part in the lengthwise direction. According to this configuration, the back coupling member is integrally connected to the back-side end of the longitudinal beam, eliminating the need for the worker to perform the work of connecting the back-side coupling member to each longitudinal beam when assembling the scaffold device. Therefore, the work of assembling the scaffold device is simplified and the time required for assembly of the scaffold device may be shortened.

Furthermore, in the scaffold device of the present invention, among the coupling members, two of the coupling members disposed at a front side in a depth direction of the frame are designated as front-side coupling members, and two of the coupling members disposed at a back side in the depth direction of the frame are designated as back-side coupling members; the coupling member has a left hole and a right hole, which are disposed in a line from left to right, and a front hole disposed further to the back side than the left hole and the right hole formed therein; the left hole and the right hole, respectively, have a straight portion along the depth direction, and a curved portion stretching to the back-side end of the straight portion and curved mutually inward; the back-side coupling member is integrally connected to the back-side end of the longitudinal beam, and the front-side end thereof is provided with a first connecting part having a hole; both ends of the transverse beam in the lengthwise direction are provided with the second connecting part having a respective hole; in a state where the hole of the first connecting part and the front hole of the front-side coupling member are opposing, a first linking pin inserted into the hole of the first connecting part and the front hole of the front-side coupling member may rotatably connect the longitudinal beam in the horizontal direction to the front-side mounting member; and in a state where the respective hole of each second connecting part is opposing, among the two back-side connecting parts opposing in the width direction of the frame, the right hole of the back-side connecting part on a left side and the left hole of the back-side connecting part on a right side, a respective second linking pin inserted into the left hole, the right hole, and the hole of each second connecting part may rotatably connect each end portion of the transverse beam in the horizontal direction to each back-side coupling member. According to this configuration, the back coupling member is integrally connected to the back-side end of the longitudinal beam, eliminating the need for the worker to perform the work of connecting the back-side coupling member to each longitudinal beam when assembling the scaffold device. Therefore, the work of assembling the scaffold device is simplified and the time required for assembly of the scaffold device may be shortened.

Furthermore, in a method of assembling a scaffold device of the present invention, the method of assembling a scaffold device is characterized as including: a step of, in a state where the hole of the first connecting part of each longitudinal beam and the front hole of each front-side coupling member are opposing, inserting the respective first linking pin into the hole of each first connecting part and the front hole of each front-side connecting member to rotatably connect each longitudinal beam in a horizontal direction to each front-side connecting member; a step of pulling the back-side end of the pair of longitudinal beams toward the respective front sides, causing the respective hole of each second connecting part of the transverse beam to oppose the right hole of the back-side coupling member on the left side and the left hole of the back-side coupling member on the right side, and inserting the respective second linking pin into the left hole, the right hole, and the hole of each second connecting part to connect each end portion of the transverse beam in the horizontal direction to each back-side connecting member; and a step of rotating the pair of longitudinal beams in the horizontal direction toward the front-side coupling member, causing the longitudinal beams and the transverse beams to be disposed in parallel. According to this configuration, even if the back-side coupling member is integrally connected to the back-side end of the longitudinal beam, the frame may be assembled by a method of linking the frame to the front-side coupling member in a folded position and then changing the frame to a unfolded position.

### Effect of Invention

According to the scaffold device and the method of assembling the scaffold device of the present invention, the weight of the components constituting the scaffold device may be reduced, which makes it possible to simplify assembly work and to shorten the time required for assembly of the scaffold device.

### BRIEF DESCRIPTION OF DRAWINGS

FIG. 1 A perspective view of a scaffold device according to a first embodiment.

FIG. 2 A perspective view of a longitudinal beam and a transverse beam according to the first embodiment.

FIG. 3 A side view of the longitudinal beam and the transverse beam according to the first embodiment.

FIG. 4 An A-A cross section of FIG. 3.

FIG. 5 A plan view of the longitudinal beam and the transverse beam according to the first embodiment.

FIG. 6 A side view of a connecting part provided at an end portion of a beam body of the longitudinal beam and the transverse beam according to the first embodiment.

FIG. 7 A front view of the longitudinal beam and the transverse beam according to the first embodiment.

FIG. 8 A perspective view of a coupling member according to the first embodiment.

FIG. 9 A longitudinal cross-sectional view illustrating in an enlarged manner the connecting part part of the coupling member of the longitudinal beam and the transverse beam according to the first embodiment.

FIG. 10 (A) is an exploded perspective view illustrating in an enlarged manner the connecting part part of the coupling member of the longitudinal beam and the transverse beam according to the first embodiment. (B) is a perspective view illustrating in an enlarged manner one portion of a fixing pin and an anti-rotation pin connecting the coupling member to the longitudinal beam and the transverse beam.

FIG. 11 A perspective view illustrating in an enlarged manner the connecting part part of a chain and the coupling member in the scaffold device according to the first embodiment.

FIG. 12 A perspective view of an intermediate beam according to the first embodiment.

FIG. 13 A longitudinal cross-sectional view of the intermediate beam according to the first embodiment.

FIG. 14 A partially enlarged side view of the intermediate beam according to the first embodiment.

FIG. 15 An exploded perspective view of the longitudinal beam and the intermediate beam according to the first embodiment.

FIG. 16 A longitudinal cross-sectional view of the longitudinal beam and the transverse beam in a state where a scaffolding plate is spanned thereover in the scaffold device according to the first embodiment.

FIG. 17 A longitudinal cross-sectional view of the longitudinal beam in a state where a bracket is connected.

FIG. 18 A side view of the bracket.

FIG. 19 A perspective view describing a method of assembling the scaffold device according to the first embodiment, wherein the drawing illustrates a state where the scaffold device assembled on the ground is suspended from a building or a structure.

FIG. 20 A perspective view describing the method of assembling the scaffold device according to the first embodiment, wherein the drawing illustrates a step of connecting a longitudinal beam for expansion to an existing frame of the scaffold device assembled on the ground.

FIG. 21 A perspective view describing the method of assembling the scaffold device according to the first embodiment, wherein the drawing illustrates a step of spanning a first intermediate beam for expansion between the longitudinal beams for expansion.

FIG. 22 A perspective view describing the method of assembling the scaffold device according to the first embodiment, wherein the drawing illustrates a step of spanning a first scaffolding plate for expansion between the longitudinal beams for expansion.

FIG. 23 A perspective view describing the method of assembling the scaffold device according to the first embodiment, wherein the drawing illustrates a step of spanning a transverse beam for expansion between coupling members for expansion.

FIG. 24 (A) is a perspective view illustrating a step of rotating one coupling member for expansion inward to connect one end of the transverse beam for expansion to one coupling member for expansion. (B) is a perspective view illustrating a step of rotating one coupling member for expansion outward to connect the other end of the transverse beam for expansion to the other coupling member for expansion.

FIG. 25 A perspective view describing the method of assembling the scaffold device according to the first embodiment, wherein the drawing illustrates a state where a scaffolding unit for expansion is linked to an existing scaffolding unit.

FIG. 26 A plan view of a frame in a scaffold device according to a second embodiment.

FIG. 27 (A) is a plan view of a longitudinal beam of the scaffold device according to the second embodiment. (B) is a side view of the longitudinal beam of the scaffold device according to the second embodiment.

FIG. 28(A) is a plan view of a transverse beam of the scaffold device according to the second embodiment. (B) is a side view illustrating a state where a telescope part of the transverse beam of the scaffold device according to the second embodiment is contracted. (C) is a side view illustrating a state where the telescope part of the transverse beam illustrated in (B) is extended.

FIG. 29 A plan view describing a method of assembling the scaffold device according to the second embodiment, wherein the drawing illustrates a state where a plurality of the frame is linked while in a folded position to a front-side coupling member.

FIG. 30 A plan view describing the method of assembling the scaffold device according to the second embodiment, wherein the drawing illustrates a state where the plurality of the frames is linked while in an unfolded position to the front-side coupling member.

FIG. 31 A perspective view describing the method of assembling the scaffold device according to the second embodiment, wherein the drawing illustrates a state where a scaffolding unit for expansion is connected to an existing scaffolding unit.

FIG. 32 A plan view of the frame in the scaffold device according to a first variation of the second embodiment.

FIG. 33 A plan view describing the method of assembling the scaffold device according to the first variation of the second embodiment, wherein the drawing illustrates a state where the plurality of the frames is linked while in a folded position to the front-side coupling member.

FIG. 34 A plan view describing the method of assembling the scaffold device according to the first variation of the second embodiment, wherein the drawing illustrates a state where the plurality of the frames is connected while in an unfolded position to the front-side coupling member.

FIG. 35 A plan view of the frame in the scaffold device according to a second variation of the second embodiment.

FIG. 36 A plan view describing the method of assembling the scaffold device according to the second variation of the second embodiment, wherein the drawing illustrates a state where the plurality of the frames is linked while in a folded position to the front-side coupling member.

FIG. 37 A plan view describing the method of assembling the scaffold device according to the second variation of the second embodiment, wherein the drawing illustrates a state where the plurality of the frames is linked while in an unfolded position to the front-side coupling member.

### EMBODIMENTS OF THE INVENTION

The following is a description of the present embodiment with reference to drawings. The same reference numerals applied throughout some drawings indicate the same components.

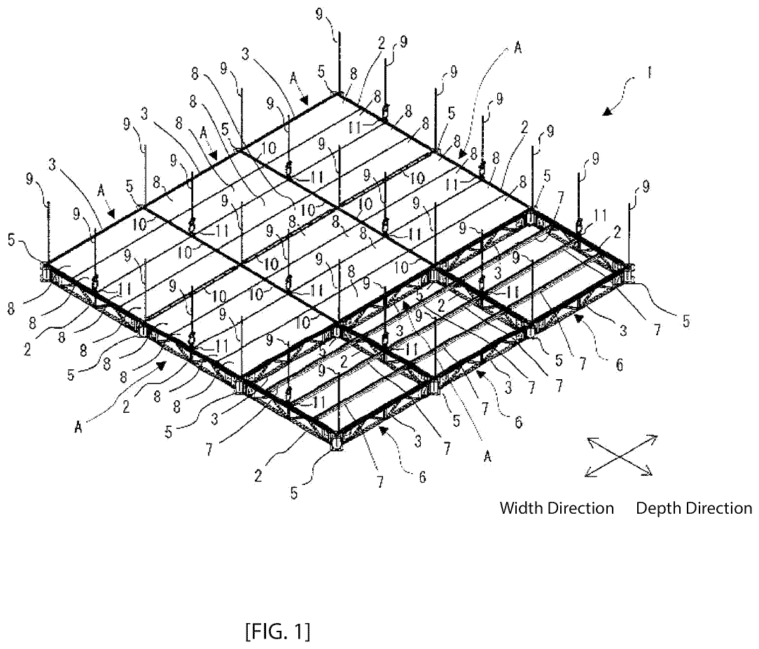

A scaffold device 1 according to a first embodiment is configured provided with a plurality of a scaffolding unit A, which is linked and disposed in a depth direction and a width direction, respectively, as illustrated in FIG. 1.

As illustrated in FIG. 1, the scaffolding unit A is provided with a frame 6 having a pair of longitudinal beams 2, 2, a pair of transverse beams 3, 3, and four coupling members 5 disposed between each end portion of the longitudinal beam 2 and each end portion of the transverse beam 3 and rotatably connecting the longitudinal beam 2 and the transverse beam 3 on the same plane; three intermediate beams 7 spanning between the longitudinal beams 2, 2 at a predetermined interval; and four scaffolding plates 8 spanning between the longitudinal beams 2, 2 and supported by at least one of the intermediate beams 7. Note that in FIG. 1, the scaffolding plate 8 is not installed on one portion of the frame 6 to facilitate an understanding of the configuration of the scaffold device 1. Furthermore, frames 6, 6 adjoining in the width direction in FIG. 1 both share the longitudinal beam 2, and frames 6, 6 adjoining in the depth direction in FIG. 1 share the transverse beam 3.

Also, as illustrated in FIG. 1, a chain 9 is connected to each coupling member 5 as a suspension material for suspending the scaffolding unit A, and by connecting an upper end of the chain 9 to a structure or building, such as a bridge, a building, or the like, the scaffold device 1 is suspended from the building or structure via the chain 9, thereby providing a scaffold for a worker performing construction or maintenance work on the building or structure.

The following is a detailed description of each portion of the scaffolding unit A, which constitutes the scaffold device 1. The frame 6 of the present embodiment is provided with the pair of longitudinal beams 2, 2, the pair of transverse beams 3, 3, and the four coupling members 5 disposed between each end portion of the longitudinal beams 2, 2 and each end portion of the transverse beams 3, 3 and rotatably connecting the longitudinal beam 2 and the transverse beam 3 in a horizontal direction; and is configured such that the position may be changed from a folded position, in which the longitudinal beam 2 is pulled in to the transverse beam 3 side, to an unfolded position, in which the longitudinal beams 2, 2 and the transverse beams 3, 3 are all disposed in parallel.

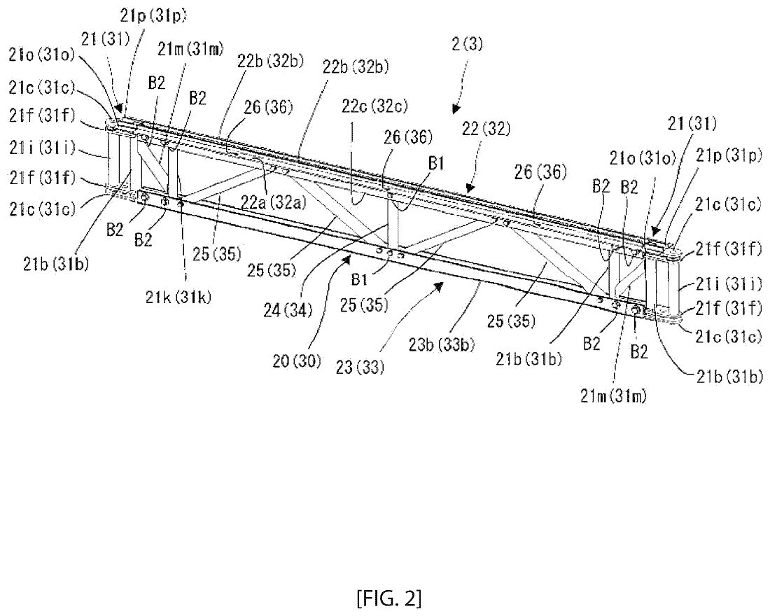

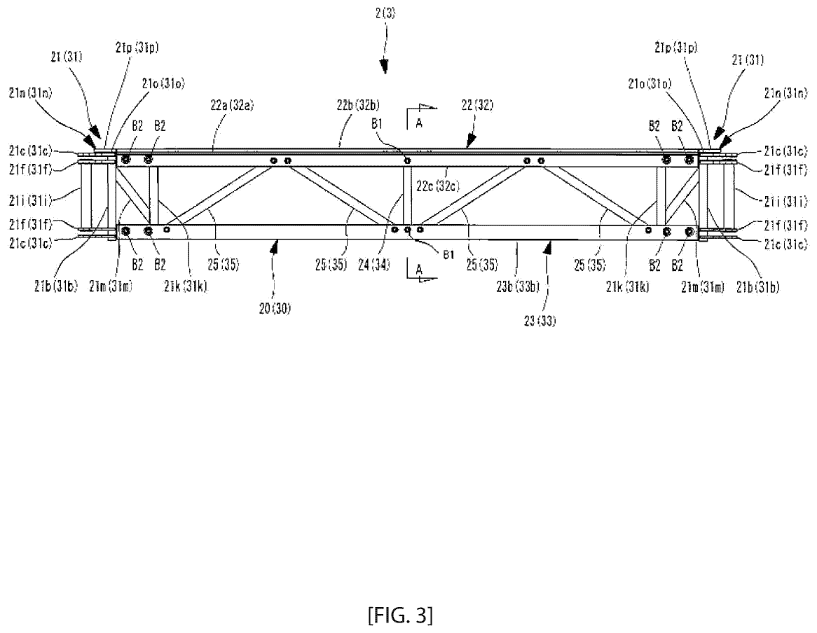

As illustrated in FIG. 2 and FIG. 3, the longitudinal beam 2 and the transverse beam 3 of the present embodiment have a beam body 20 (30) made of aluminum, and a connecting part 21 (31) made of steel, which is detachably connected to both ends of the beam body 20 (30), respectively, in a lengthwise direction and capable of connecting the beam body 20 (30) to the coupling member 5, to be described later.

The connecting part 21 (31) of the present embodiment is formed of steel, a material that has a higher rigidity than the beam body 20 (30), in this manner because it is a portion linked to the coupling member 5 and subject to a large shear load when the scaffold device 1 is in use. On the other hand, compared to the connecting part 21 (31), the beam body 20 (30) is formed of aluminum, which is less rigid than steel but has a smaller mass per unit volume and is lighter than steel, because the load acting thereon is smaller than that on the connecting part 21 (31) when the scaffold device 1 is in use.

Thus, the weight of the longitudinal beam 2 and the transverse beam 3 of the present embodiment is reduced compared to when both the beam body 20 (30) and the connecting part 21 (31) are made of steel, without reducing the load capacity of the scaffold device 1.

Note that the beam body 20 (30) being made of steel and the connecting part 21 (31) being made of aluminum constitutes one example; provided that the beam body 20 (30) is formed of a material having a lower mass per unit volume than the connecting part 21 (31) and the connecting part 21 (31) is formed of a material having a higher rigidity than the beam body 20 (30), the weight of the longitudinal beam 2 and the transverse beam 3 may be reduced without reducing the load capacity of the scaffold device 1. However, the beam body 20 (30) and the connecting part 21 (31) may be formed of the same material.

Furthermore, as illustrated in FIG. 2 and FIG. 3, the beam body 20 (30) is provided with an upper chord member 22 (32) and a lower chord member 23 (33), which are disposed opposing at the top and bottom and mutually parallel; a bundle member 24 (34), which spans vertically between the upper chord member 22 (32) and the lower chord member 23 (33) and connects the upper chord member 22 (32) and the lower chord member 23 (33); and a plurality of a diagonal member 25 (35), which spans diagonally between the upper chord member 22 (32) and the lower chord member 23 (33), thereby forming a beam member having a truss structure.

Note that in the present embodiment, the beam body 20 (30) has a truss structure wherein the upper chord member 22 (32) is connected to the lower chord member 23 (33) by the diagonal member 25 (35) to ensure strength, but the structure of the beam body 20 (30) is not limited to a truss structure provided that the necessary strength is assured.

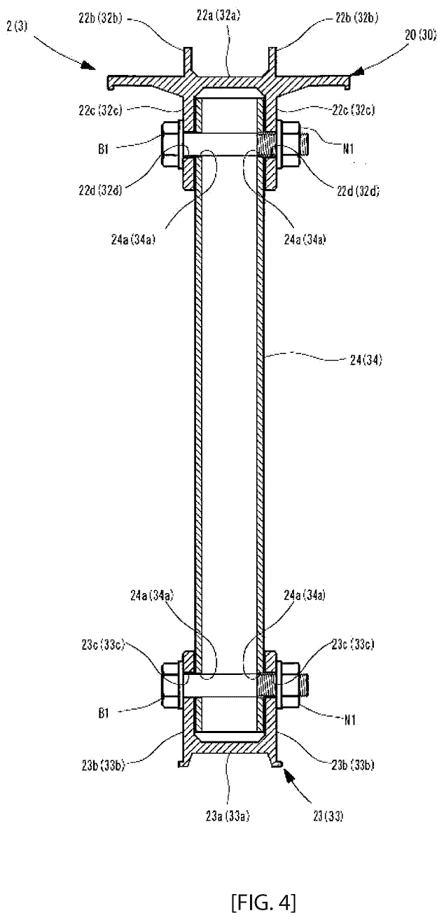

Furthermore, as illustrated in FIG. 4, the upper chord member 22 (32) is provided with a flat plate-shaped scaffolding plate support portion 22a (32a) extending along the beam body 20 (30) in the lengthwise direction; a pair of positioning pieces 22b, 22b (32b, 32b) standing upward from an upper surface of the scaffolding plate support portion 22a (32a), provided along the beam body 20 (30) in the lengthwise direction, and mutually opposing having an interval therebetween; and a pair of holding pieces 22c, 22c (32c, 32c) standing downward from a lower surface of the scaffolding plate support portion 22a (32a), provided along the beam body 20 (30) in the lengthwise direction, and mutually opposing to clamp the bundle member 24 (34) and the diagonal member 25 (35).

Furthermore, as illustrated in FIG. 4, the lower chord member 23 (33) has a substantially U-shaped cross section, formed of a bottom piece 23a (33a), and side pieces 23b, 23b (33b, 33b), which stand vertically from both ends of the bottom piece 23a (33a), mutually opposing, to clamp the bundle member 24 (34) and the diagonal member 25 (35), and is disposed so that an opening side faces the upper chord member 22 (32) side.

Moreover, the holding pieces 22c, 22c (32c, 32c) of the upper chord member 22 (32) are provided with mutually opposing holes 22d, 22d (32d, 32d) at a predetermined interval along the beam body 20 (30) in the lengthwise direction. Furthermore, the side pieces 23b, 23b (33b, 33b) of the lower chord member 23 (33) are also provided with mutually opposing holes 23c, 23c (33c, 33c) at a predetermined interval along the beam body 20 (30) in the lengthwise direction.

Also, as illustrated in FIG. 4, an upper end and a lower end of the bundle member 24 (34) are disposed between the holding pieces 22c, 22c (32c, 32c) of the upper chord member 22 (32) and between the side pieces 23b, 23b (33b, 33b) of the lower chord member 23 (33), respectively; a hole 24a (34a) provided at the upper end and the lower end, respectively, of the bundle member 24 (34) is made to oppose the hole 22d (32d) provided in holding pieces 22c, 22c (32c, 32c) and holes 23c, 23c (33c, 33c) provided in side pieces 23b, 23b (33b, 33b) of the lower chord member 23 (33), respectively; and a respective bolt B1 is inserted into each of the opposing holes and a nut N1 is screwed onto the bolt B1 from the opposite side and tightened, causing the bundle member 24 (34) to be connected by nut and bolt between the upper chord member 22 (32) and the lower chord member 23 (33).

Furthermore, although not illustrated, a hole is also provided at an upper end and a lower end of the diagonal member 25 (35), respectively, and the diagonal member 25 (35) is connected between the upper chord member 22 (32) and the lower chord member 23 (33) by the bolt B1 and the nut N1 according to the same procedure as the bundle member 24 (34).

Thus, in the present embodiment, the upper chord member 22 (32), the lower chord member 23 (33), the bundle member 24 (34), and the diagonal member 25 (35) are mutually connected in a detachable form using the bolt B1 and the nut N1. Therefore, even if any of the components constituting the beam body 20 (30) are damaged or deformed due to aging or a load, only the damaged or deformed components need to be detached and replaced, making maintenance simple.

Furthermore, as described above, the beam body 20 (30) of the present embodiment is made of aluminum, but welding aluminum is labor intensive, and it is extremely costly to attempt to connect the upper chord member 22 (32), the lower chord member 23 (33), the bundle member 24 (34), and the diagonal member 25 (35) by welding. In contrast, in the present embodiment, because the bolt B1 and the nut N1 are used to connect the upper chord member 22 (32), the lower chord member 23 (33), the bundle member 24 (34), and the diagonal member 25 (35), the beam body 20 (30) may be made into a truss structure while avoiding welding.

Note that the means of connecting the upper chord member 22 (32), the lower chord member 23 (33), the bundle member 24 (34), and the diagonal member 25 (35) in a detachable form is not limited to the means of connection using the bolt B1 and the nut N1. Furthermore, although welding costs are high when the beam body 20 (30) is made of aluminum, each component constituting the beam body 20 (30) may be connected by welding.

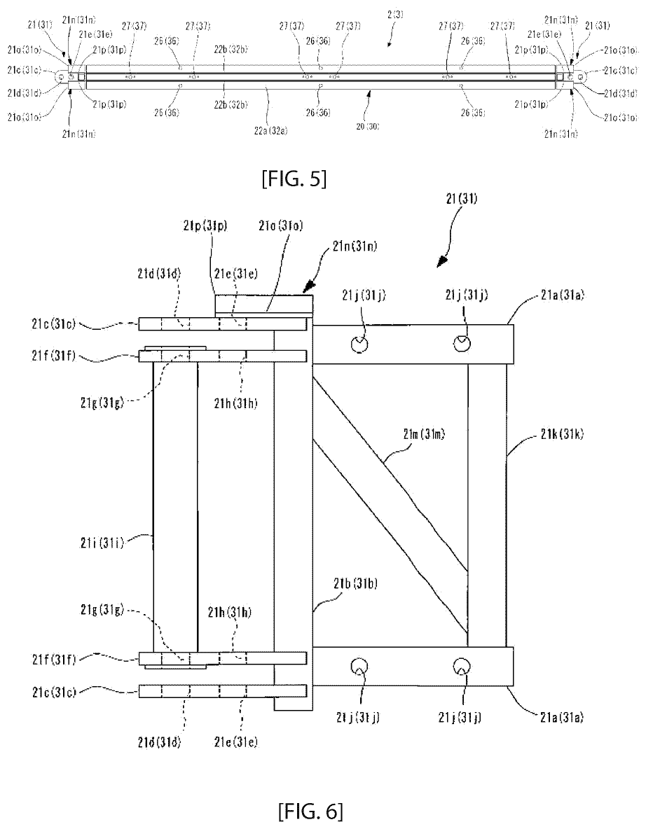

Furthermore, as illustrated in FIG. 5, three respective hook holes 26 (36) are disposed at a predetermined interval along the beam body 20 (30) in the lengthwise direction at a portion of the scaffolding plate support portion 22a (32a) that is more outward than the positioning pieces 22b, 22b (32b, 32b) in the width direction, and a pin body 71d of a hook part 71 provided at the end portion of the intermediate beam 7, which will be described later, may be inserted in the hook hole 26 (36) to connect the intermediate beam 7 to the beam body 20 (30). However, the number of hook holes 26 (36) is not limited to three; the number of hook holes 26 (36) should be exactly same as the number of intermediate beams 7 spanning between the longitudinal beams 2, 2.

Moreover, as illustrated in FIG. 5, six screw holes 27 (37) are provided in a line along the beam body 20 (30) in the lengthwise direction between the positioning pieces 22b, 22b (32b, 32b) in the scaffolding plate support portion 22a (32a) of the upper chord member 22 (32). However, the number of screw holes 27 (37) is not limited to six; any number may be provided.

Furthermore, in the present embodiment, as illustrated in FIG. 5, the six screw holes 27 (37) are disposed two at a time, each spaced at an interval on the left side, center, and right side in the drawing, and the interval between the two screw holes 27, 27 (37, 37) disposed in the center is narrower than the interval between the two screw holes 27, 27 (37, 37) disposed at the left side and the right side, respectively. Note that the screw holes 27 (37) are formed by a nut 27c (37c), which will be described later.

Returning, as illustrated in FIG. 6, the connecting part 21 (31) of the present embodiment is provided with a pair of upper and lower fixing members 21a, 21a (31a, 31a) having a rectangular cylindrical-shaped cross section, a linking member 21b (31b) having a square cylindrical-shaped cross section, which spans between and is connected to one end of the pair of fixing members 21a, 21a (31a, 31a), and a pair of upper and lower flat plate-shaped connecting pieces 21c, 21c (31c, 31c) is provided at an upper end side and a lower end side, respectively, of the connecting member 21b (31b), protruding along the fixing member 21a (31a) in an axial direction.

Also, the pair of upper and lower fixing members 21a, 21a (31a, 31a) of the connecting part 21 (31) is inserted between the pair of holding pieces 22c, 22c (32, 32c) of the upper chord member 22 (32) and between the pair of side pieces 23b, 23b (33b, 33b) of the lower chord member 23 (33), respectively, from an end portion of the beam body 20 (30), and in a state where two holes 21j (31j) provided in a line in the pair of fixing members 21a, 21a (31a, 31a) and two holes (not illustrated) provided in a line in the side piece 23b (33b) and the holding piece 22c of the beam body 20 (30), respectively, are opposing, a bolt B2 is inserted into these holes and a nut (not illustrated) is screwed onto the bolt B2 from the opposite side and tightened, causing the connecting part 21 (31) to be detachably connected to each end portion of the beam body 20 (30), as illustrated in FIG. 2 and FIG. 3.

Note that the method of connecting the connecting part 21 (31) to the beam body 20 (30) is not particularly limited as long as the connecting part 21 (31) and the beam body 20 (30) may be detached.

Furthermore, as illustrated in FIG. 6, each connecting piece 21c (31c) is provided with a first mounting hole 21d (31d) disposed at a tip side and a second mounting hole 21e (31e) disposed at a base end side. The first mounting hole 21d (31d) and the second mounting hole 21e (31e) are provided in a line along the beam body 20 (30) in the lengthwise direction to each connecting piece 21c (31).

Furthermore, as illustrated in FIG. 6, a pair of upper and lower flat plate-shaped support pieces 21f, 21f (31f, 31f) opposing each connecting piece 21c (31c) is provided between the pair of connecting pieces 21c, 21c (31c, 31c) of the linking member 21b (31b). Moreover, each support piece 21f (31f) is provided with a first opposing hole 21g (31g) that opposes the first mounting hole 21d (31d) of the connecting piece 21c (31c) and a second opposing hole 21h (31h) that opposes the second mounting hole 21e (31e) of the connecting piece 21c (31c). Furthermore, a cylinder member 21i (31i), which is cylinder-shaped and whose tube ends are supported by the respective support pieces 21f, 21f (31f, 31f), spans between the pair of support pieces 21f, 21f (31f, 31f). Both tube ends of the cylinder member 21i (31i) oppose the respective first opposing hole 21g (31g), and an inside of the cylinder member 21i (31i) is joined to the first opposing hole 21g (31g).

Furthermore, as illustrated in FIG. 6, the connecting part 21 (31) of the present embodiment is provided with a bundle member 21k (31k), which vertically spans between the pair of fixing members 21a, 21a (31a, 31a), and a diagonal member 21m (31m), which diagonally spans between the bundle member 21k (31k) and the linking member 21b (31b). The connecting part 21 (31) also forms a truss structure including the diagonal member 21m (31m), which increases the strength of the connecting part 21 (31).

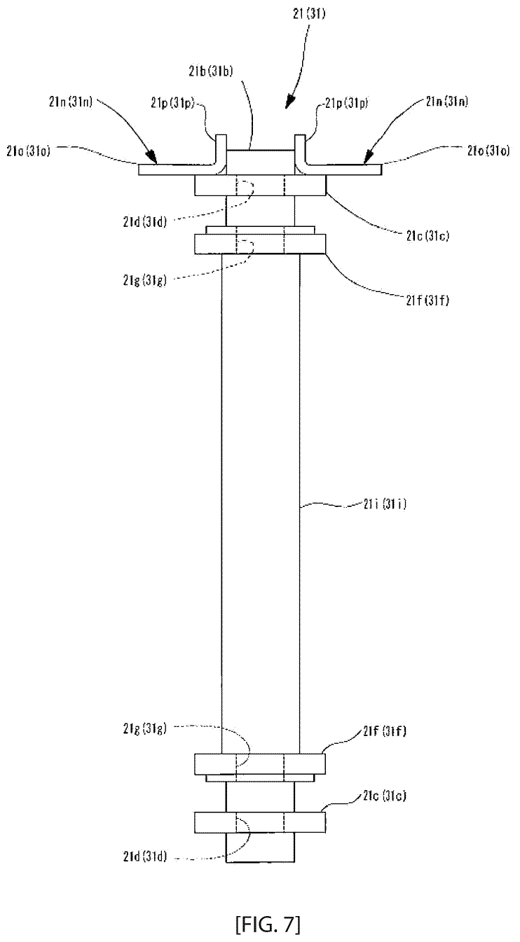

Moreover, as illustrated in FIG. 6 and FIG. 7, on the upper surface of the connecting piece 21c (31c) on the upper side, two L-shaped pieces 21n (31n) having an L-shaped cross section provided with a bottom portion 210 (310) extending along the upper surface of the connecting piece 21c (31c) and a vertical portion 21p (31p) protruding vertically from a side end of the bottom portion 210 (310) are disposed and connected so that the vertical portions 21p (31p) in FIG. 7 are made to face and the bottom portions 210 (310) protrude mutually outward.

Furthermore, an upper surface of the bottom portion 210 (310) of each L-shaped piece 21n (31n) is flush with the upper surface of the scaffolding plate support portion 22a (32a) of the upper chord member 22 (32), as illustrated in FIG. 3, and a side surface of the vertical portion 21p (31p) of each L-shaped piece 21n (31n) is flush with a side surface of each positioning piece 22b (32b), as illustrated in FIG. 5.

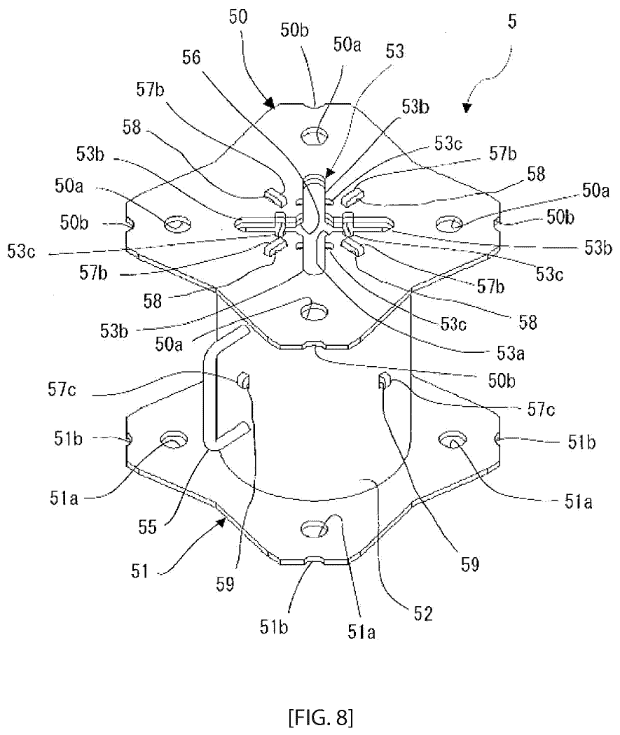

Continuing, the coupling member 5 of the present embodiment will be described in detail. As illustrated in FIG. 8, the coupling member 5 of the present embodiment is provided with a pair of upper and lower plates 50, 51, which are disposed in parallel, and a cylinder-shaped linking part 52 for linking the upper side plate 50 and the lower side plate 51. Furthermore, a U-shaped grip part 55 is provided at a perimeter of the linking part 52, and this functions as a handle when carrying the coupling member 5.

As illustrated in FIG. 6, the upper side plate 50 and the lower side plate 51 are plate members having a shape formed by four connected isosceles trapezoids surrounding the four sides of a square; each trapezoidal portion is provided with four insertion holes 50a, 51a disposed at an equal interval on the same circumference and mutually opposing, and four anti-rotation grooves 50b, 51b provided at the tip, at a position directly facing the insertion holes 50a, 51a when viewed from the center of each plate 50, 51.

Note that the shape of the upper side plate 50 and the lower side plate 51 described above is one example and is not limited to any particular shape; the shape may be circular or rectangular. Furthermore, the shape of the linking part 52 is also not limited to a cylindrical shape; for example, it may be a square cylinder.

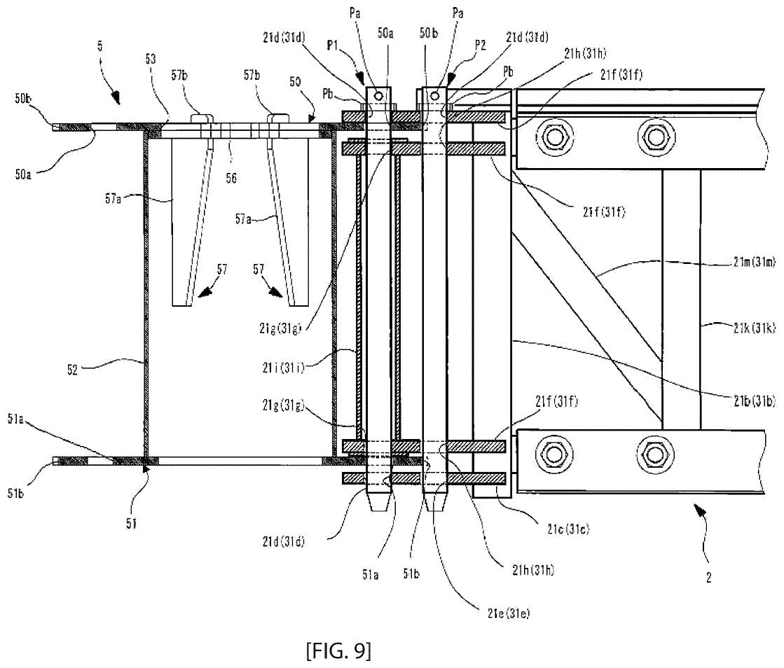

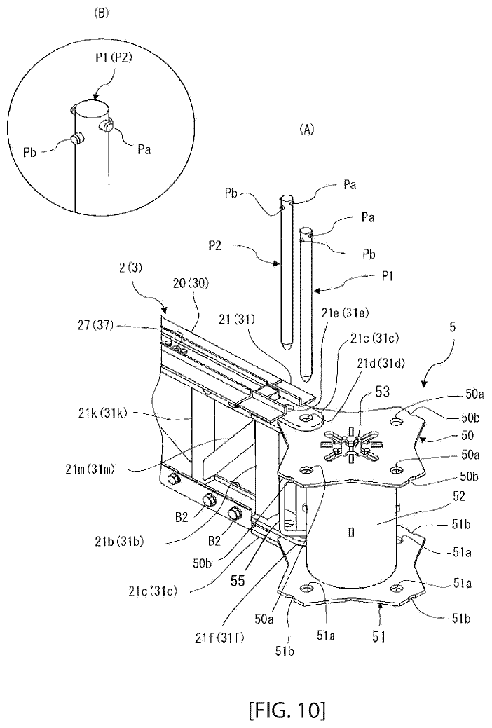

Also, as illustrated in FIG. 9 and FIG. 10(A), the upper side plate 50 is inserted between the connecting piece 21c (31c) of the upper side and the support piece 21f (31f) of the upper side in the connecting part 21 (31) of the longitudinal beam 2 and the transverse beam 3, the lower side plate 51 is inserted between the connecting piece 21c (31c) of the lower side and the support piece 21f (31f) of the lower side, and in addition, the insertion holes 50a, 51a of each plate 50, 51 and the first mounting holes 21d, 21d (31d, 31d) of the connecting piece 21c, 21c (31c, 31c) of the connecting part 21 (31) are opposing. In this state, a fixing pin P1 is inserted into the first mounting holes 21d, 21d (31d, 31d) and the insertion holes 50a, 51a, causing the coupling member 5 to rotatably connect to the longitudinal beam 2 and the transverse beam 3 in the horizontal direction.

Furthermore, the anti-rotation grooves 50b, 51b provided on the perimeter of each plate 50, 51 of the coupling member 5 are provided so as to oppose the second mounting hole 21e of the connecting part 21 (31) in a state where the insertion holes 50a, 51a are opposing the first mounting holes 21d (31d) of the connecting part 21 (31).

Therefore, as illustrated in FIG. 9, when an anti-rotation pin P2 is inserted into the second mounting holes 21e, 21e (31e, 31e) in a state where the fixing pin P1 is inserted into the first mounting holes 21d, 21d (31d, 31d) and the insertion holes 50a, 51a, the anti-rotation pin P2 is also inserted into the anti-rotation grooves 50b, 51b. Thus, the coupling member 5 is supported on two axes with respect to the longitudinal beam 2 and the transverse beam 3; therefore, the coupling member 5 is fixed to the longitudinal beam 2 and the transverse beam 3 in a non-rotatable state. When the longitudinal beam 2 and the transverse beam 3 are fixed to the coupling member 5 in this manner, the longitudinal beam 2 and the transverse beam 3 are connected to the coupling member 5 in a mutually orthogonal position when the frame 6 is viewed from above.

Furthermore, as illustrated in FIG. 10(B), the upper ends of the fixing pin P1 and the anti-rotation pin P2 are provided with two pin-shaped protrusions Pa, Pb in a vertical line that pass through and protrude from the fixing pin P1 and the anti-rotation pin P2 in the radial direction, and these protrusions Pa, Pb are disposed facing a mutually intersecting direction when viewing from the axial direction of the fixing pin P1 and the anti-rotation pin P2. Note that in the present embodiment, these protrusions Pa, Pb are provided passing through the fixing pin P1 and the anti-rotation pin P2 in the radial direction; however, they may be formed so as to protrude in only one direction in the radial direction from the fixing pin P1 and the anti-rotation pin P2 without passing through the fixing pin P1 and the anti-rotation pin P2.

Also, the upper side protrusion Pa functions as a handle for the fixing pin P1 and the anti-rotation pin P2, and the lower side protrusion Pb functions as a retainer, catching on an edge of the first mounting hole 21d (31d) and the second mounting hole 21e (31) when the fixing pin P1 and the anti-rotation pin P2 are inserted into the first mounting hole 21d (31d) and the second mounting hole 21e (31e).

Furthermore, in the present embodiment, two holes (not illustrated) passing through the fixing pin P1 and the anti-rotation pin P2 in the radial direction are opened in the upper end portion of the fixing pin P1 and the anti-rotation pin P2, intersecting when viewing the fixing pin P1 and the anti-rotation pin P2 from the axial direction and also vertically staggered, and the respective upper side protrusion Pa and the lower side protrusion Pb are inserted into these holes and welded, thereby connecting the upper side protrusion Pa and the lower side protrusion Pb to the fixing pin P1 and the anti-rotation pin P2. In other words, the two holes are provided at a vertical, twisted position with respect to each pin P1, P2.

Furthermore, in the present embodiment, the upper side protrusion Pa and the lower side protrusion Pb are disposed facing a mutually intersecting direction when viewing the fixing pin P1 and the anti-rotation pin P2 from the axial direction; however, they may be disposed vertically and in parallel.

However, when the upper side protrusion Pa and the lower side protrusion Pb are disposed vertically and in parallel, if a thickness is not ensured between the two holes provided on the upper end side of the fixing pin P1 and the anti-rotation pin P2 for connecting the upper side protrusion Pa and the lower side protrusion Pb to the fixing pin P1 and the anti-rotation pin P2, hole drilling will not be successful; therefore, it is necessary to leave an interval of a certain degree between the holes in the vertical direction.

In contrast, as in the present embodiment, when the upper side protrusion Pa and the lower side protrusion Pb are disposed in an intersecting direction when viewing from the axial direction of the fixing pin P1 and the anti-rotation pin P2, the two holes into which the upper side protrusion Pa and the lower side protrusion Pb are inserted are positioned at a twisted position; therefore, even if the distance between the two holes in the vertical direction is shortened, hole drilling may be carried out without difficulty.

Therefore, when the upper side protrusion Pa and the lower side protrusion Pb are disposed in an intersecting direction when viewing from the axial direction of the fixing pin P1 and the anti-rotation pin P2, the interval in the vertical direction between the upper side protrusion Pa and the lower side protrusion Pb may be made shorter than when the upper side protrusion Pa and the lower side protrusion Pb are disposed vertically and in parallel. Thus, the fixing pin P1 and the anti-rotation pin P2 are inserted into the first mounting hole 21d (31d) and the second mounting hole 21e (31e), making it possible to reduce the protruding height of the upper ends of the fixing pin P1 and the anti-rotation pin P2 in a state where the lower side protrusion Pb is hooked on the edges of the first mounting hole 21d (31d) and the second mounting hole 21e (31).

When the protruding height of the upper ends of the fixing pin P1 and the anti-rotation pin P2 is lowered in this manner, even if the plate thickness of the scaffolding plate 8, described below, which is placed on the scaffolding plate support portion 22a of the upper chord member 22 of the longitudinal beams 2,2, is reduced to make the scaffolding plate 8 lighter, as illustrated in FIG. 9, the position of the upper ends of the fixing pin P1 and the anti-rotation pin P2 may be disposed at the same position as the upper end surface of the scaffolding board 8 or at a lower position than the upper end surface of the scaffolding board 8, and it is therefore possible to prevent a worker from tripping over the fixing pin P1 and the anti-rotation pin P2.

Furthermore, there is a slight gap between the fixing pin P1 inserted into the first mounting hole 21d, (31d) and the insertion holes 50a, 51a, and the first mounting holes 21d, 21d (31d, 31d) and the insertion holes 50a, 51a, to allow smooth insertion of the fixing pin P1. Therefore, the upper end of the fixing pin P1 inserted into the first mounting holes 21d, 21d (31d, 31d) and the insertion holes 50a, 51a tilts, as illustrated in FIG. 9, toward the lower end, on the right side in the drawing, inside the first mounting holes 21d, 21d (31d, 31d) and the insertion holes 50a, 51a to the extent of the foregoing gap due to a moment incurred from the longitudinal beam 2 and transverse beam 3.

Therefore, although not illustrated, in a state where the coupling member 5 is connected to the longitudinal beam 2 and the transverse beam 3 using only the fixing pin P1, the longitudinal beam 2 and the transverse beam 3 tilt downward according to the inclination angle of the fixing pin P1.

On the other hand, as illustrated in FIG. 9, there is a slight gap between the anti-rotation pin P2 inserted in the second mounting hole 21e (31e) and the second mounting holes 21e, 21e (31e, 31e), and the anti-rotation groove 51b of the lower side provided in the lower side plate 51 is formed shallower than the anti-rotation groove 50b of the upper side provided in the upper side plate 50. Therefore, as illustrated in FIG. 9, the upper end of the anti-rotation pin P2 inserted into the second mounting holes 21e, 21e (31e, 31e) attempts to tilt toward the lower end, the right side in FIG. 9, in the second mounting holes 21e, 21e (31e, 31e) due to a moment incurred from the longitudinal beam 2 and the transverse beam 3; however, the lower end is supported from a side by the lower side plate 51, and tilting is suppressed.

In other words, in the present embodiment, the lower end of the anti-rotation pin P2 is supported from the side by the lower side plate 51, even if it is subjected to a moment from the longitudinal beam 2 and the transverse beam 3; therefore, the longitudinal beam 2 and the transverse beam 3 may be disposed horizontally.

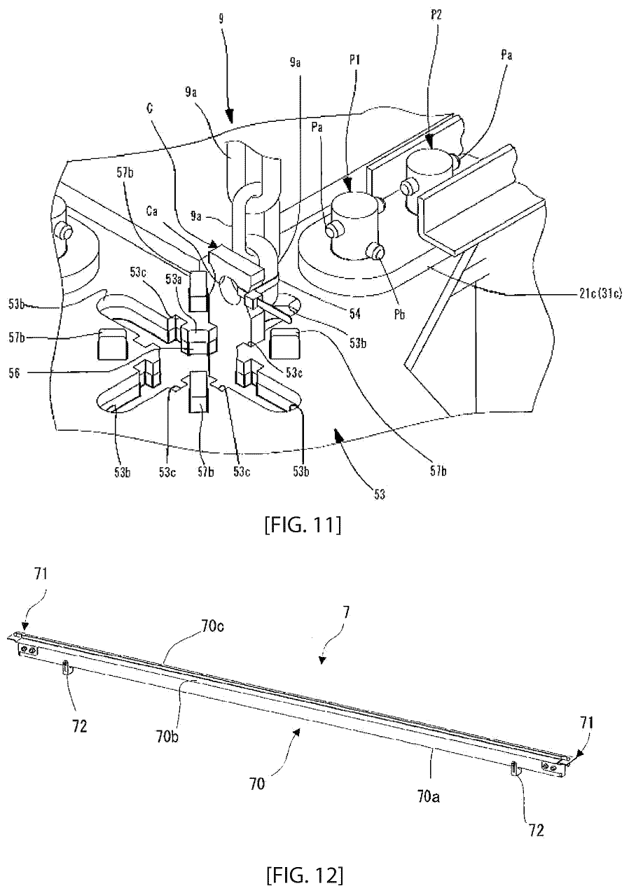

Returning, as illustrated in FIG. 8 and FIG. 11, a chain fixing hole 53 capable of connecting the lower end of the chain 9 is provided at the center of the upper side plate 50. Specifically, as illustrated in FIG. 8, a chain fixing hole 53 of the present embodiment is formed in a cross shape having a center hole portion 53a that allows insertion of the chain 9, and four protrusion hole portions 53b that respectively extend in the radial direction from the center hole portion 53a toward each insertion hole 50a side. Moreover, the chain fixing hole 53 has a notched groove portion 53c crossing an extension direction of each protrusion hole portion 53b.

Therefore, as illustrated in FIG. 11, when the chain 9 is inserted into the center hole portion 53a and then a ring 9a constituting the chain 9 is moved in a transverse direction along the protrusion hole portion 53b and inserted into the protrusion hole portion 53b, which is wider than the thickness of the ring 9a and narrower than its transverse width, a ring 9a below the ring 9a thereof is oriented orthogonal to the protrusion hole portion 53b, and the chain 9 will not be pulled out from the protrusion hole portion 53b of the upper side plate 50.

Moreover, as illustrated in FIG. 11, in the state where the chain 9 is inserted into the protrusion hole portion 53b, a chain fixing plate C is inserted into the notched groove portion 53c, a restraining band 54 is passed through a hole Ca provided on the upper end side of the chain fixing plate C and inside the ring 9a of the chain 9, and the restraining band 54 fixes the chain fixing plate C and the chain 9, which also restricts movement of the chain 9 in the transverse direction.

In the present embodiment, the lower end of the chain 9 is connected to the chain fixing hole 53 of the coupling member 5 in this manner; however, the above-described connection method is one example, and the chain 9 may be connected to the coupling member 5 by another method. Furthermore, the suspension material for suspending the scaffolding unit A does not need to be the chain 9.

Furthermore, as illustrated in FIG. 8 and FIG. 9, a reinforcement plate 56 is fixed to the lower surface of the upper side plate 50 by four ribbed plates 57 that are connected to the upper side plate 50 and the linking part 52. This reinforces the upper side plate 50 of the coupling member 5, which is suspended by the chain 9.

Specifically, as illustrated in FIG. 8, a respective first fitting hole 58 is formed between adjoining protrusion hole portions 53b, 53b of the upper side plate 50. Also, a respective second fitting hole 59 is formed in the linking part 52 at the same positions as each first fitting hole 58 in a circumferential direction.

Furthermore, as illustrated in FIG. 9, the reinforcement plate 56 is a circular plate material having substantially the same outer diameter as an inner diameter of the linking part 52, and has a hole of the same shape and opposes the first fitting hole 58 and the chain fixing hole 53 provided in the upper side plate 50. Moreover, as illustrated in FIG. 9, the rib plate 57 has a rib body 57a, a first fitting portion 57b provided at an upper end of the rib body 57a and capable of fitting to the first fitting hole 58, and a second fitting portion 57c provided at a lower end of the rib body 57a and capable of fitting to the second fitting hole 59.

Also, in a state where the reinforcement plate 56 is in contact with the lower surface of the upper side plate 50, the first fitting portion 57b of each rib plate 57 is fitted into the first fitting hole 58, the second fitting portion 57c of each rib plate 57 is fitted into the second fitting hole 59, and the first fitting portion 57b of each rib plate 57 is welded to the upper side plate 50, causing the reinforcing plate 56 to be clamped by the upper side plate 50 and the rib body 57a of four rib plates 57 and fixed to the lower surface of the upper side plate 50. However, the reinforcement plate 56 may be omitted provided that the upper side plate 50 is sufficiently strong.

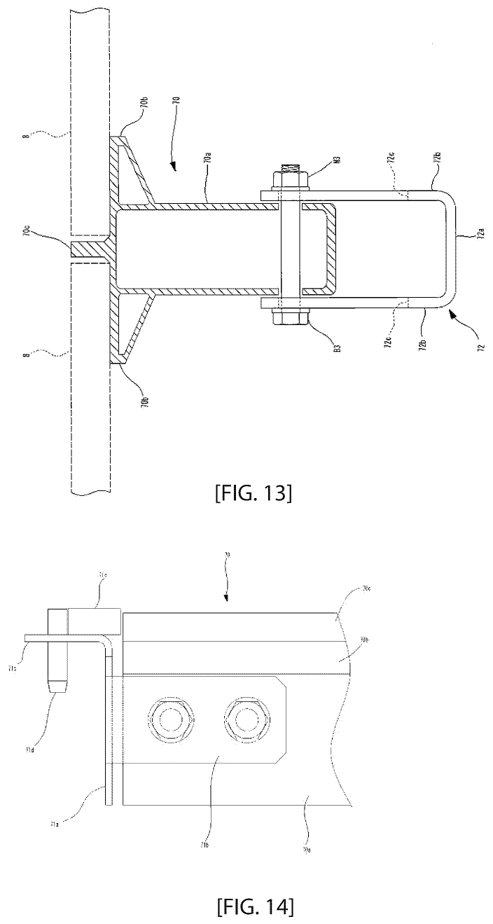

Continuing, the structure of the intermediate beam 7 spanning between adjoining longitudinal beams 2, 2 will be described in detail as illustrated in FIG. 1. As illustrated in FIG. 12, the intermediate beam 7 of the present embodiment is provided with an intermediate beam body 70, and a respective hook part 71 provided at both end portions of the intermediate beam body 70 in the lengthwise direction. Specifically, as illustrated in FIG. 13, an intermediate beam body 70 is provided with a body portion 70a having a rectangular tube-shaped cross section, overhang portions 70b, 70b respectively overhanging laterally from both side ends of an upper portion of the body portion 70a in the width direction and whose upper surfaces are flush with the upper surface of the body portion 70a, and a protrusion portion 70c standing from a center of the upper portion of the body portion 70a in the width direction and extending along the body portion 70a in the axial direction.

Furthermore, as illustrated in FIG. 12 and FIG. 13, a respective grip part 72 is connected to each side of the body portion 70a of the intermediate beam body 70 in the axial direction, and the grip part 72 serves as a handle for the intermediate beam 7.

Specifically, as illustrated in FIG. 13, the grip part 72 is provided with a rectangular plate-shaped bottom piece 72a, and a pair of opposing pieces 72b, 72b standing from both ends of the bottom piece 72a and mutually opposing, and a long hole 72c is formed on each opposing piece 72b, extending along its own extension direction and mutually opposing. Also, in a state where each long hole 72c is opposing a hole (not illustrated) provided in the body portion 70a of the intermediate beam body 70, a bolt B3 is inserted into the foregoing hole provided in the body portion 70a, and a nut N3 is screwed onto the bolt B3 from the opposite side and tightened so that the grip part 72 is movably connected to the intermediate beam body 70 along the long hole 72c in the extension direction. Thus, when the grip part 72 is moved so that the bottom piece 72a is brought closer to the body portion 70a side, a height of the intermediate beam 7 may be reduced, thus enabling a reduction in the space required when the intermediate beam 7 is stored.

Furthermore, as illustrated in FIG. 14, the hook part 71 of the present embodiment is provided with a flat plate-shaped vertical piece 71a extending along the main body 70a of the intermediate beam body 70 in a height direction; a pair of side plates 71b, 71b fastened to the end portion of the body portion 70a by a bolt and nut not attached at two locations in a state extending vertically from both side ends of the vertical piece 71a to the vertical piece 71a and gripping the end portion of the body portion 70a; a flat plate-shaped horizontal piece 71c extending from the upper end of the vertical piece 71a toward the side opposite to the intermediate beam; a pin body 71d inserted into a hole (not illustrated) that vertically passes through the horizontal piece 71c, where the tip protrudes downward from the horizontal piece 71c; and a standing piece 71e extending from a base end of the pin body 71d toward the intermediate beam body 70 side and welded to an upper surface of the horizontal piece 71c. Furthermore, as illustrated in FIG. 12 and FIG. 14, the standing piece 71e is a rectangular flat-plate shape, and a thickness of the standing piece 71e is the same thickness as the protrusion portion 70c of the intermediate beam body 70, resulting in there being no step between the standing piece 71e and a convex portion 70c when viewing the intermediate beam 7 from the axial direction. Furthermore, as described above, the intermediate beam 7 of the present embodiment is formed by connecting the intermediate beam body 70 and the hook part 71, which are constituted as separate members, in a detachable form using a bolt and a nut not indicated as mutual.

Therefore, in the present embodiment, the intermediate beam body 70 may be formed of aluminum, a lightweight but labor-intensive metal to weld, and the hook part 71 may be formed of highly rigid steel. Thus, when the intermediate beam body 70 is made of aluminum, it is lighter than when the intermediate beam 7 is constituted by steel only, making carrying easier and the work of installing the intermediate beam 7 simpler.

However, the intermediate beam body 70 may be formed of a material other than aluminum. Furthermore, when the intermediate beam body 70 is formed of steel, for example, the intermediate beam body 70 and the hook part 71 may be integrated by welding. Furthermore, the structure of the intermediate beam 7 of the present embodiment is one example and is not limited to the structure described above.

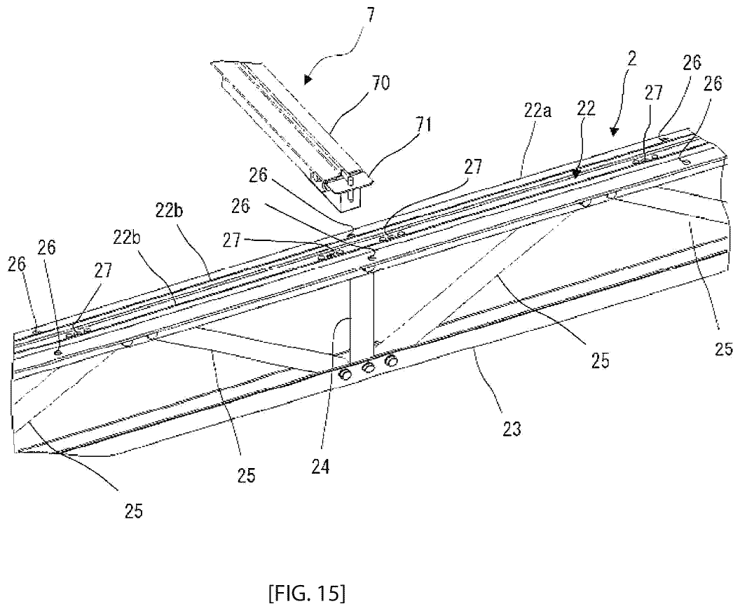

Also, as illustrated in FIG. 15, inserting the respective pin body 71d of each hook part 71 into the hook holes 26 provided in each scaffolding plate support portion 22a of the pair of longitudinal beams 2, 2 constituting the frame body 6 causes the intermediate beam 7 configured in this manner to span between the longitudinal beams 2, 2. Furthermore, in the present embodiment, three hook holes 26 are provided on one side of the scaffolding plate support portion 22a of one longitudinal beam 2 to enable three intermediate beams 7 to span between the longitudinal beams 2, 2 of one frame 6, as illustrated in FIG. 1.

Continuing, the scaffolding plate 8, which spans between the longitudinal beams 2, 2, will be described in detail. The scaffolding plate 8 of the present embodiment is a rectangle-shaped wooden board, as illustrated in FIG. 1. Note that the material of the scaffolding plate 8 is not particularly limited as long as the necessary strength is ensured; however, if the scaffolding plate 8 is made of wood, it will be lightweight, making carrying the scaffolding plate 8 easier and the work of installing the scaffolding plate 8 simpler. Furthermore, if the scaffolding plate 8 is made of metal, it is preferable that the scaffolding plate 8 be formed of a lightweight metal, such as aluminum.

Furthermore, in the scaffold device 1 of the present embodiment, as illustrated in FIG. 1, the scaffolding plate 8 is installed between the pair of longitudinal beams 2, 2, at two locations on the front side and back side of the frame 6 between the mutually opposing transverse beam 3 and the intermediate beam 7 in the depth direction, and at two locations between three mutually opposing intermediate beams 7, 7, respectively. Therefore, in the present embodiment, four scaffolding plates 8 are installed on one frame 6.

When a scaffold of one scaffolding unit A is constituted by four scaffolding plates 8 in this manner, the area per single scaffolding plate 8 is smaller when the area of the frame 6 of the scaffolding unit A is the same compared to a case where the scaffold of one scaffolding unit A is constituted by one scaffolding plate 8 or a case where the scaffold of one scaffolding unit is composed of two scaffolding plates as in the scaffold device of Patent Literature 1. Thus, the weight of each scaffolding plate 8 may be reduced compared to that which is conventional, making carrying the scaffolding plate 8 easier and the work of installing the scaffolding plate 8 simpler.

Note that the number of scaffolding plates 8 constituting the scaffold of one scaffolding unit A is not limited to four, and three or more may be used to reduce the weight per scaffolding plate 8 compared to that which is conventional.

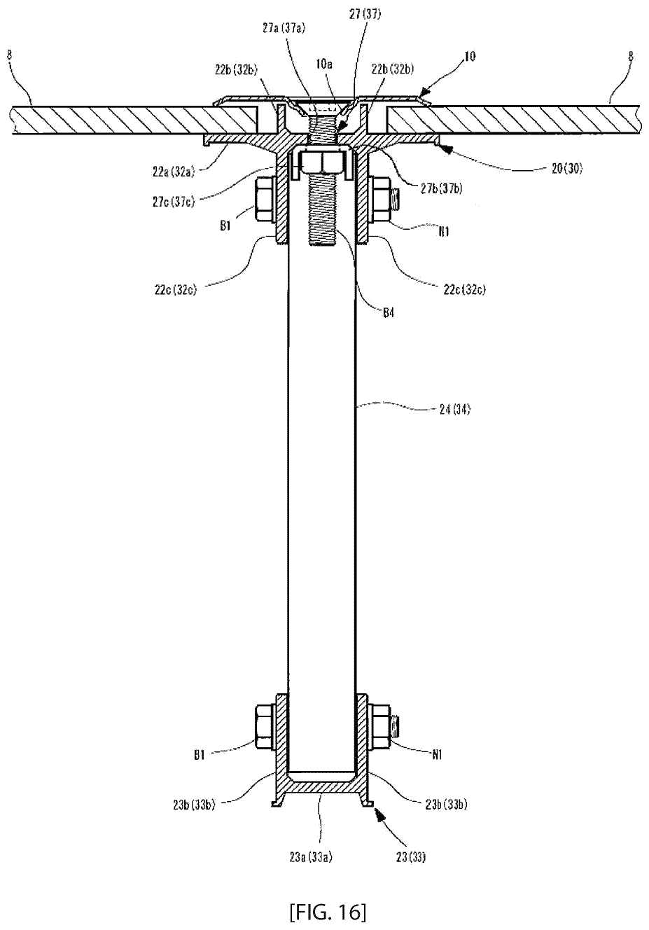

Furthermore, as illustrated in FIG. 13 and FIG. 16, the scaffolding plate 8 is placed on the scaffolding plate support portion 22a (32a) of the longitudinal beam 2 and the transverse beam 3 and the overhang portion 70b of the intermediate beam 7 and spans between the pair of longitudinal beams 2, 2.

Moreover, the periphery of the scaffolding plate 8 installed on the front side and back side of the frame 6 in the depth direction is surrounded by the positioning piece 22b of the longitudinal beam 2, the positioning piece 32b of the transverse beam 3, and the protrusion portion 70c of the intermediate beam 7, and the perimeter of the scaffolding plate 8 installed between the three intermediate beams 7, 7 of the frame 6 is surrounded by the positioning piece 22b of the transverse beam 2 and the protrusion portion 70c of the intermediate beam 7. Therefore, the scaffolding plate 8, which spans between the pair of longitudinal beams 2, 2, is positioned having movement in the horizontal direction restricted.

Furthermore, as illustrated in FIG. 13 and FIG. 16, the thickness of the scaffolding plate 8 of the present embodiment is equal to the protruding height of the positioning pieces 22b, 22b (32b, 32b) and the protrusion portion 70c. Therefore, the positioning pieces 22b, 22b (32b, 32b) and the protrusion portion 70c do not protrude above the scaffolding plate 8 from the gap between adjacent scaffolding plates 8, 8. Thus, it may be possible to prevent the worker from tripping over the positioning pieces 22b, 22b (32b, 32b) and the protrusion portion 70c.

Moreover, as illustrated in FIG. 1 and FIG. 16, the present embodiment is provided with a fixing plate 10 that is fixed to the upper chord member 22 (32) of the longitudinal beam 2 and the transverse beam 3, clamping the scaffolding plate 8 placed on the scaffolding plate support portion 22a (32a) to the scaffolding plate support portion 22a (32a) and also preventing the scaffolding plate 8 from falling off from the frame 6.

The fixing plate 10 provided in this manner is provided along the upper chord member 22 (32) of the longitudinal beam 2 and the transverse beam 3 in the lengthwise direction, filling the gap between the adjoining scaffolding plates 8, 8 on one longitudinal beam 2 and transverse beam 3 to eliminate a step and also pressing the scaffolding plate 8 against the scaffolding plate support portion 22a (32a) side to prevent the scaffolding plate 8 from rising up.

Specifically, as illustrated in FIG. 1 and FIG. 16, the fixing plate 10 of the present embodiment is a rectangular-shaped plate having a plurality of bolt insertion holes 10a disposed at the same intervals as the plurality of screw holes 27 (37) provided in the scaffolding plate support portion 22a (32a).

Here, as illustrated in FIG. 16, the screw hole 27 (37) is formed by the nut 27c (37c) provided via a fixture 27b (37b) on the lower surface between the positioning pieces 22b, 22b (32b, 32b) of the scaffolding plate support portion 22a (32a), and a hole 27a (37a) provided at a location where the nut 27c (37c) of the scaffolding plate support portion 22a, 22a, (32a, 32a) is attached, allowing insertion of a bolt.

Also, as illustrated in FIG. 16, in a state where the fixing plate 10 grips the positioning pieces 22b, 22b (32b, 32b) of the scaffolding plate support portion 22a (32a) of the longitudinal beam 2 and the transverse beam 3 and covers the respective scaffolding plates 8 placed on the left side and the right side in the drawing, and the bolt insertion hole 10a of the fixing plate 10 opposes the screw hole 27 (37) of the longitudinal beam 2 and the transverse beam 3, a bolt B4 is inserted into the bolt insertion hole 10a and the bolt B4 is screwed into the nut 27c (37c) of the screw hole 27 (37), causing the fixing plate 10 to be pressed against the longitudinal beam 2 and the transverse beam 3 by a head portion of the bolt B4 and thereby fixed to the longitudinal beam 2 and the transverse beam 3.

Note that in the present embodiment, although two fixing plates 10 are fixed to one longitudinal beam 2 and transverse beam 3, the number of and locations where the fixing plates 10 are installed may be arbitrarily determined as needed, and the fixing plates 10 need not be fixed to all the screw holes 27 (37) in the longitudinal beam 2 and the transverse beam 3.

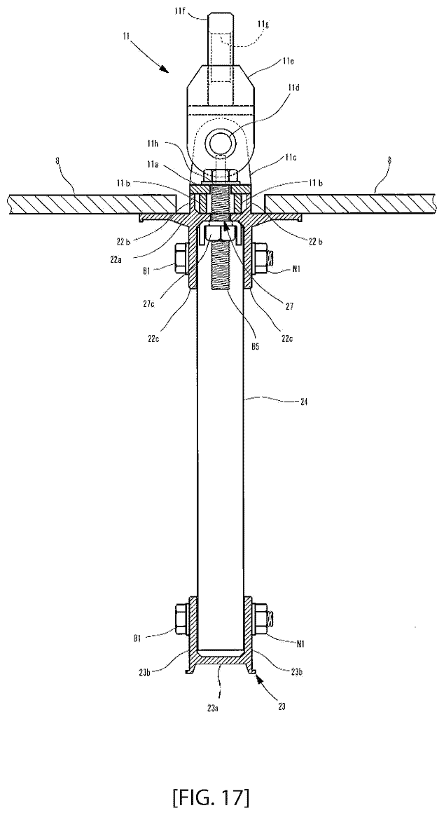

Furthermore, as illustrated in FIG. 1 and FIG. 17, a bracket 11 capable of attaching the chain 9 as a suspension material for suspending the frame 6 may be connected to the screw hole 27 in the longitudinal beam 2.

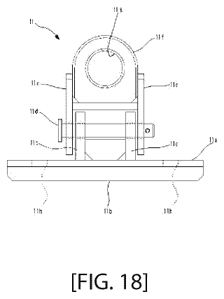

Specifically, as illustrated in FIG. 17 and FIG. 18, the bracket 11 of the present embodiment is provided with a rectangular bottom plate 11a, a pair of restricting pieces 11b, 11b protruding from a bottom portion of the bottom plate 11a and inserted between the positioning pieces 22b, 22b to oppose the positioning pieces 22b, 22b, and a pair of support pieces 11c, 11c protruding from an upper portion of the bottom plate 11a and mutually opposing, a pair of rotating pieces 11e, 11e rotatably connected to the pair of support pieces 11c, 11c via a rotation pin 11d, and a chain holding portion 11f fixed between the rotating pieces 11e, 11e and having a joining hole 11g through which the chain 9 may be inserted.

Furthermore, the bottom plate 11a is provided with two holes 11h, 11h, which are disposed at the same interval as the two screw holes 27, 27 that are disposed at the axial direction center of the beam body 20 of the longitudinal beam 2 in FIG. 5.

Also, as illustrated in FIG. 17, in a state where the holes 11h, 11h of the bottom plate 11a are opposing the two screw holes 27, 27 disposed at the axial direction center of the beam body 20, a bolt B5 is inserted into each hole 11h of the bottom plate 11a and the bolt B5 is screwed onto the nut 27c of the screw hole 27, causing the bracket 11 to be fixed to the longitudinal beam 2. Furthermore, at this time, in a state where the restricting pieces 11b, 11b are inserted between the positioning pieces 22b, 22b to restrict movement of the bracket 11 in the width direction with respect to the longitudinal beam 2, the bolt B5 may be inserted into the hole 11h of the bottom plate 11a; therefore, positioning of the hole 11h and the screw hole 27 in the bottom plate 11a becomes simpler.

Furthermore, although not specifically illustrated, inserting the chain 9 into the joining hole 11g of the bracket 11 and hooking the chain 9 to the bracket 11 makes it possible to attach the chain 9 to the frame 6 via the bracket 11; therefore, in the scaffold device 1, the chain 9 for suspending the scaffold device 1 may also be attached to a location other than where the coupling member 5 is disposed, and the load capacity of the scaffold device 1 may be increased.

Moreover, in the bracket 11 of the present embodiment, the rotating pieces 11e, 11e to which the chain holding portion 11f is fixed are rotatably connected to the support pieces 11c, 11c, so that even if the position of the chain 9 connected to the building or structure is not directly above the bracket 11, the rotating pieces 11e, 11e will rotate, preventing the bracket 11 from being subjected to a moment load.

Furthermore, as illustrated in FIG. 17, a width of the bracket 11 of the present embodiment (width from left and right in the drawing) is narrower than the width between the adjoining scaffolding plates 8, 8 in the width direction. Specifically, a length by which the bracket 11 juts out from an upward extension line of an outward end surface of each positioning piece 22b, 22b in the bracket 11 is shorter than half the length obtained by subtracting the length of the scaffolding plate 8 from the length between the positioning pieces 22b, 22b in the longitudinal beam 2, 2 (transverse beam 3, 3). Therefore, even in a state where the bracket 11 is fixed to the longitudinal beam 2, the scaffolding plate 8 may be placed on the scaffolding plate support portion 22a of the longitudinal beam 2 without being obstructed by the bracket 11.

Furthermore, in the present embodiment, the bracket 11 is attached only to longitudinal beam 2; however, the bracket 11 may be attached only to the transverse beam 3 or to both the longitudinal beam 2 and the transverse beam 3. Furthermore, the configuration of the bracket 11 of the present embodiment is one example, and is not limited to the structure described above provided that the chain 9 may be attached as the suspension material. Furthermore, the bracket 11 may be omitted provided that there is no deficiency in the load capacity of the scaffold device 1.

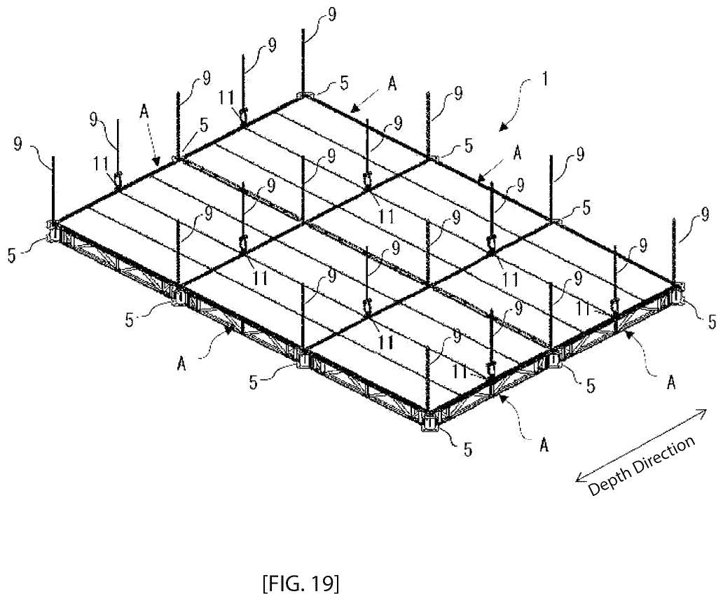

Continuing, the method of assembling the scaffold device 1 of the present embodiment will be described in detail. First, the scaffold device 1 is assembled on the ground, constituted by the plurality of the scaffolding units A connected in the depth direction and the width direction. Also, the upper end of the chain 9, which is connected to the bracket 11 and the coupling member 5 provided to each scaffolding unit A of the scaffold device 1 assembled on the ground (hereinafter referred to as an “existing scaffolding unit A”), is attached to the building or structure side, and the chain 9 is hoisted up by heavy machinery or a chain block to suspend the scaffold device 1 from the building or structure, as illustrated in FIG. 19.

In the present embodiment, as illustrated in FIG. 19, the scaffold device 1 is constituted by six existing scaffolding units A disposed in three rows in the width direction and two rows in the depth direction, where the existing scaffolding units A, A adjacent in the width direction have the longitudinal beam 2 as a common component, and the existing scaffolding units A, A adjacent in the depth direction have the transverse beam 3 as a common component. Note that the number of existing scaffolding units A constituting the scaffold device 1 may be appropriately determined as needed, and at least one is sufficient.

Next, a step of connecting a scaffolding unit μl for expansion to the existing scaffolding unit A of the scaffold device 1 suspended from a building or structure to expand the floor plate area of the scaffold device 1 will be described in detail. Here, for convenience of description, the constituent components of the scaffolding unit μl for expansion are marked with different reference numerals from those of the existing scaffolding unit A; however, the constituent components of the scaffolding unit μl for expansion and those of the existing scaffolding unit A are the same components.

First, a coupling member 5A for expansion is connected in advance to one end of a longitudinal beam 2A for expansion, and the bracket 11 is attached to the screw holes 27, 27 in the axial direction center.

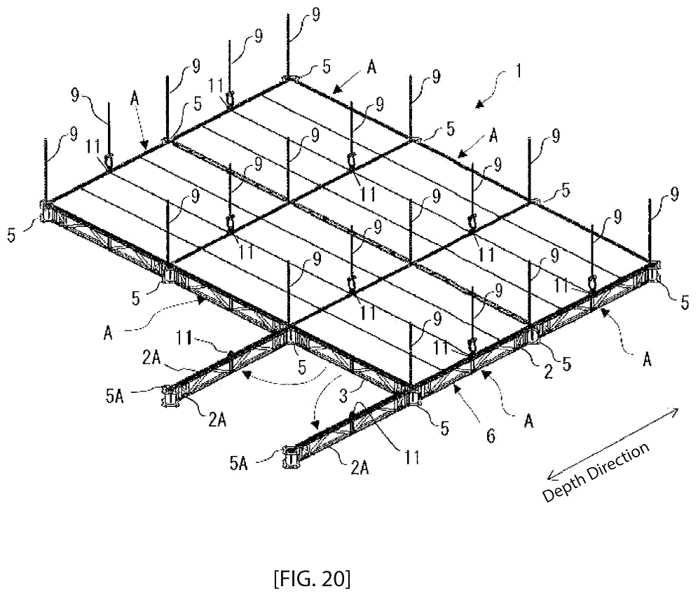

Also, as illustrated in FIG. 20, the other end of the longitudinal beam 2A for expansion, to which the coupling member 5A for expansion is attached at one end, is rotatably connected by only a respective fixing pin P1 in the horizontal direction to each of the existing coupling members 5 disposed on one side (left side in the drawing), the side of the existing frame 6 to be expanded of the existing scaffolding unit A. At this time, the worker performs work on one existing scaffolding unit A, which is connected to the existing coupling member 5 in a state where one end of the longitudinal beam 2A for expansion is pulled toward the scaffolding unit A side where the work is to be performed. From this state, the worker rotates one end of each longitudinal beam 2A for expansion outward and in the horizontal direction away from the scaffolding unit A using the existing coupling member 5 as a fulcrum, which disposes the pair of longitudinal beams 2A for expansion so that they are mutually parallel along the depth direction. Thereafter, the other end of the longitudinal beam 2A for expansion and each of the existing coupling members 5 are fixed in a non-rotatable state by the anti-rotation pin P2.

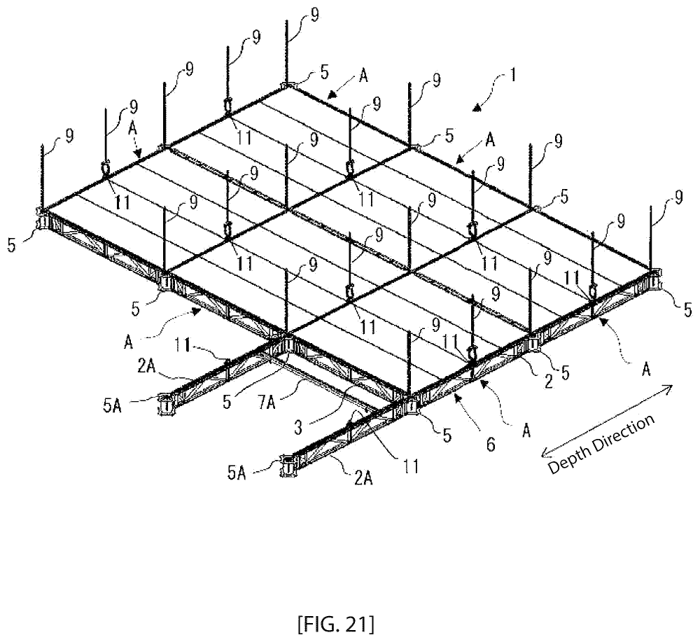

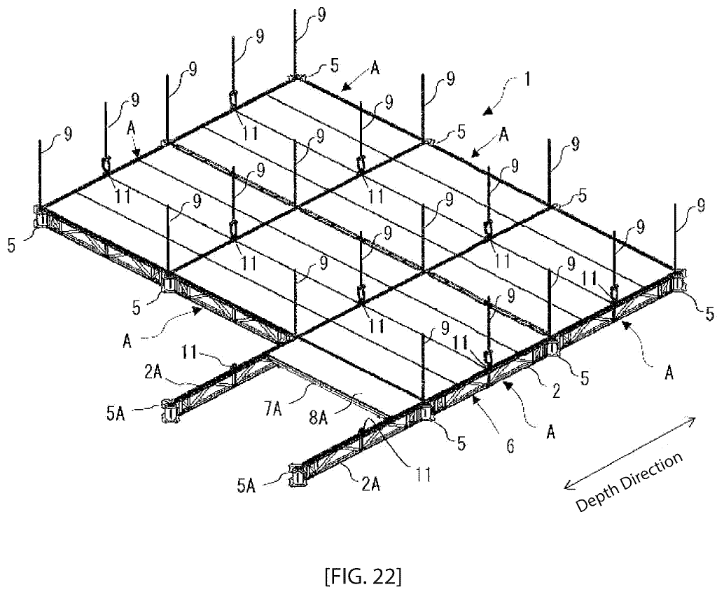

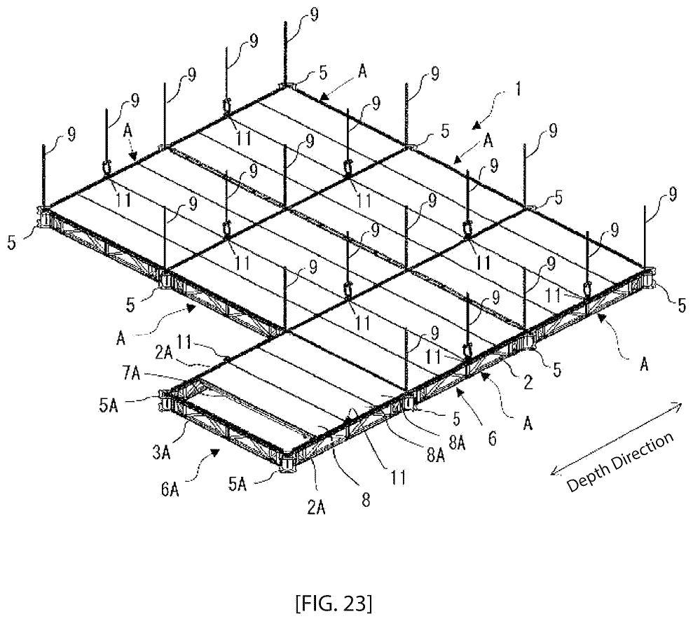

Next, as illustrated in FIG. 21, the respective hook part 71 provided on both ends of a first intermediate beam 7A for expansion is hooked onto the hook hole 26, which is on a first front side of each longitudinal beam 2A for expansion when viewed from the existing scaffolding unit A, and the first intermediate beam 7A for expansion then spans between the longitudinal beams 2A, 2A for expansion. Thereafter, as illustrated in FIG. 22, a first scaffolding plate 8A for expansion spans between the longitudinal beams 2A, 2A for expansion while being supported by the existing transverse beam 3 and the first intermediate beam 7A for expansion of the existing scaffolding unit A. The worker performs this work on the existing scaffolding unit A; however, in the scaffold device 1 of the present embodiment, three intermediate beams 7 are provided for one frame 6, so the distance from the existing scaffolding unit A to the first intermediate beam 7A for expansion is short, allowing the worker to safely perform the foregoing work.

Also, although not illustrated, for the second and third intermediate beams 7A and the scaffolding plate 8A for expansion, the intermediate beam 7A for expansion and the scaffolding plate 8A for expansion span between the longitudinal beams 2A, 2A for expansion in order from the front side according to the same procedure as the first intermediate beam 7A for expansion and the first scaffolding plate 8A for expansion. Even when performing this work, since the width between the intermediate beams 7A, 7A for expansion is narrow, the worker is able to safely perform the work without having to lean out far from above the scaffolding plate 8A for expansion, which is installed between the longitudinal beams 2A, 2A for expansion. Note that the second and third scaffolding plates 8A for expansion are supported by two adjoining intermediate beams 7A, 7A for expansion in the depth direction.

Next, as illustrated in FIG. 23, a transverse beam 3A for expansion spans between the coupling members 5A, 5A for expansion connected to one end of each longitudinal beam 2A for expansion. The procedure for spanning the transverse beam 3A for expansion between the coupling members 5A, 5A for expansion will be described in detail below.

First, when connecting the coupling member 5A for expansion to one end of the longitudinal beam 2A for expansion, the coupling member 5A for expansion is connected to one end of the longitudinal beam 2A for expansion using only the fixing pin P1, which is capable of rotating in the horizontal direction with respect to the one end of the longitudinal beam 2A for expansion.

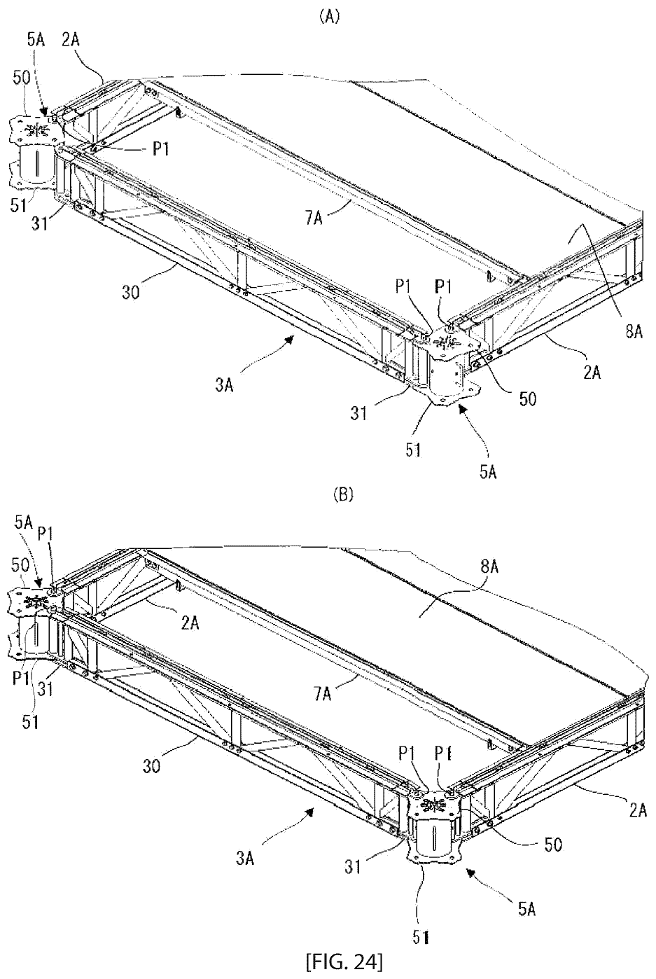

In this state, as illustrated in FIG. 24(A), in a state where the coupling member 5A for expansion on the right side in the drawing is rotated toward the longitudinal beam 2A for expansion side (inward) on the left side in the drawing, bringing the coupling member 5A for the extension on the right side in the drawing closer to the scaffolding plate 8A for expansion, the connecting part 31 at one end of the transverse beam 3A for expansion, at the right side in the drawing, is moved from the front side to the back side in the depth direction and stacked vertically on the pair of plates 50, 51 of the coupling member 5A for expansion on the right side in the drawing, and in a state where the holes of the connecting part 31 (first mounting hole 31d, first opposing hole 31g) on the right side in the drawing and the insertion holes 50a, 51a of the coupling member 5A for expansion on the right side in the drawing are opposing, the fixing pin P1 is inserted and the right end of the transverse beam 3A for expansion in the drawing is connected rotatably in the horizontal direction to the coupling member 5A for expansion on the right side in the drawing.

Thereafter, as illustrated in FIG. 24(B), in a state where the coupling member 5A for expansion on the right side in the drawing is rotated toward the opposite side (outward) of the longitudinal beam 2A for expansion on the left side in the drawing, the connecting part 31, at the left end in the drawing, which is the other end of the transverse beam 3A for expansion, is stacked vertically on the plates 50, 51 of the coupling member 5A for expansion on the left side in the drawing, and the holes of the connecting part 31 (first mounting hole 31d, first opposing hole 31g) on the left end in the drawing of the transverse beam 3A for expansion and the insertion holes 50a, 51a of the plates 50, 51 of the coupling member 5A for expansion on the left side in the drawing are opposing, the fixing pin P1 is inserted and the left end of the transverse beam 3A for expansion in the drawing is connected rotatably in the horizontal direction to the coupling member 5A for expansion on the left side in the drawing.

Provided that the coupling member 5A for expansion is rotatably connected to one end of the longitudinal beam 2A for expansion in the horizontal direction without being fixed, one of the coupling members 5A for expansion may be rotated inward to bring one of the coupling members 5A for expansion closer to the scaffolding plate 8A for expansion side, thus reducing the amount that the worker has to lean out from the scaffolding plate 8A for expansion, and allowing the worker to assemble the scaffold device 1 in a safer manner.

Furthermore, when the scaffold device 1 is assembled, it may become difficult for the transverse beam 3A for expansion to span between the coupling members 5A, 5A for expansion due to a dimensional error in each component constituting the scaffold device 1, misalignment of each component during assembly, or the like. In contrast, in the present embodiment, by simply rotating outward one of the coupling members 5A for expansion, to which one end of the transverse beam 3A for expansion is connected in a rotated inward state, the holes (first mounting hole 31d, first opposing hole 31g) of the connection part 31 at the other end of the transverse beam 3A for expansion and the insertion holes 50a, 51a of the plates 50, 51 of the other coupling member 5A for expansion are made to oppose; therefore, it is simple to align the holes of the connecting part 31 and the holes of the plates 50, 51 of the coupling member 5A for expansion, even if there is a dimensional error in each component constituting the scaffold device 1, misalignment of each component during assembly, or the like.

Thus, when the transverse beam 3A for expansion spans between the coupling members 5A, 5 A for expansion according to the method described above, the work of assembling the scaffold device 1 will be safer and simpler.

Note that in the present embodiment, both the left and right coupling members 5A for expansion are rotatably connected to one end of the left and right longitudinal beams 2A for expansion, respectively, in the horizontal direction; however, provided that at least one coupling member 5A for expansion is rotatably connected to one end of the longitudinal beam 2A for expansion in the horizontal direction, the transverse beam 3A for expansion may span between the coupling members 5A, 5A for expansion according to the same procedure as that described above.

However, both the left and right coupling members 5A for expansion may be fixed in advance in a non-rotatable state to the longitudinal beam 2A for expansion by the anti-rotation pin P2. Even in this case, the transverse beam 3A for expansion may span between the coupling members 5A, 5A for expansion.

Returning, although not illustrated, the end portion of each longitudinal beam 2A for expansion and each end portion of the transverse beam 3A for expansion are fixed in a non-rotatable state to each coupling member 5A for expansion via the anti-rotation pin P2.

Also, the fourth scaffolding plate 8A for expansion spans between the longitudinal beams 2A, 2A for expansion while being supported by the third intermediate beam 7A for expansion and the transverse beam 3A for expansion.

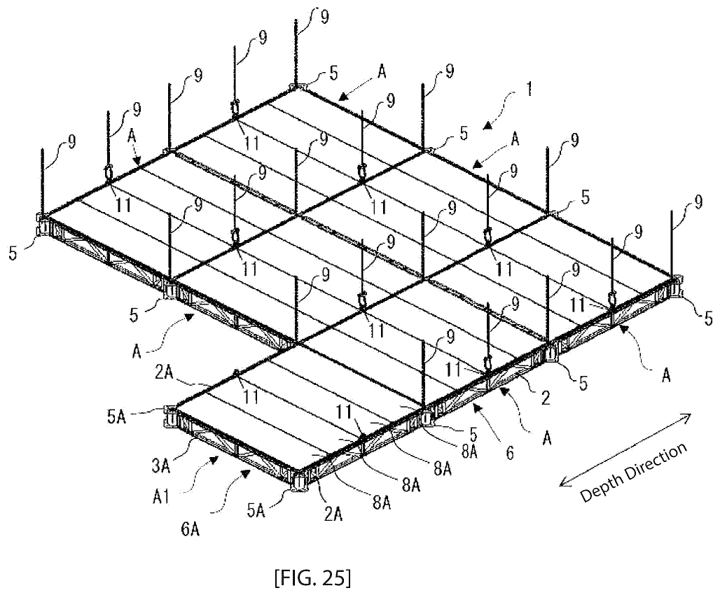

Finally, attaching the lower end of the chain 9, the upper end of which is connected to the building or structure side, to the coupling member 5A for expansion and the bracket 11 previously attached to the longitudinal beam 2A for expansion causes the scaffolding unit μl for expansion to be suspended from the building or structure, as illustrated in FIG. 25.

At this time, since the bracket 11 is attached to the longitudinal beam 2A for expansion in advance, the lower end of chain 9 may be attached to the bracket 11 immediately after all scaffolding plates 8A for expansion are installed on one frame 6A for expansion, and the time during which the scaffolding unit μl for expansion is not suspended via the chain 9 attached to the bracket 11 may be shortened, thereby improving safety.

Repeating the foregoing procedure in the width direction or the depth direction makes it possible to expand the floorboard area of the scaffold device 1 of the present embodiment to any desired position in a state where suspended from a building or structure. Also, after assembling a plurality of the scaffolding units μl for expansion and expanding the floor plate area of the scaffold device 1, a fixing panel 10 may be fixed to each longitudinal beam 2 and each transverse beam 3 to prevent the scaffolding plate 8 from falling off.

Note that since the worker is able to connect the longitudinal beams 2, 2 to the existing scaffolding unit A, unfold them, and perform work on one scaffolding unit A, the plurality of the existing scaffolding units A stretch out in the width direction, and when installing the scaffolding unit μl for expansion, forming one row in the width direction, on the plurality of the existing scaffolding units A in the depth direction, it is sufficient to prepare and perform work on every other existing scaffolding unit A lined up in the width direction regarding the longitudinal beams 2, 2, thereby improving work efficiency.

According to the method of assembling the scaffold device 1 described above, the step of connecting the end portions of the plurality of longitudinal beams 2 and the transverse beams 3 to one coupling member 5 is eliminated at once. Therefore, it is difficult to make an error in determining which of the insertion holes 50a, 51a from among the four insertion holes 50a, 51a provided in the coupling member 5 should be used to connect the longitudinal beam 2 and the transverse beam 3. Thus, according to the foregoing method of assembly, assembly errors are less likely to occur and assembly workability is improved.

Furthermore, as described above, in the scaffold device 1 of the present embodiment, the scaffold of the scaffolding unit A is constituted by three or more scaffolding plates 8, which makes the width of the scaffolding plate 8 narrower and the weight per scaffolding plate 8 lighter compared to when the scaffold of the conventional scaffolding unit is constituted by two or less scaffolding plates. Moreover, the beam body 20 (30) of the longitudinal beam 2 and the transverse beam 3 and the intermediate beam body 70 of the intermediate beam 7 are made of lightweight aluminum in an attempt to achieve a lighter weight. Thus, in the present embodiment, since carrying each component constituting the scaffold device 1 is simple, the work of installing the scaffold device 1 is simple, and the time required for assembly of the scaffold device 1 may be shortened.

Furthermore, since the width of the scaffolding plate 8 is narrower, the width between the intermediate beams 7, 7 supporting the scaffolding plate 8 is also narrower, allowing the worker to assemble the scaffold device 1 without having to lean out far from above the existing scaffolding unit A or from the already installed scaffolding plate 8 for expansion. Thus, the scaffold device 1 may be assembled in a safer manner.

Note that the method of assembling the scaffold device 1 described above is one example, and is not limited to the foregoing method provided that the scaffold device 1 can be assembled.

As described above, the scaffold device 1 of the present embodiment is provided with the frame 6 having the pair of longitudinal beams 2, 2, the pair of transverse beams 3, 3, and four coupling members 5 disposed between each end portion of the longitudinal beam 2 and each end portion of the transverse beam 3 and rotatably connecting the longitudinal beam 2 and the transverse beam 3 on the same plane; two or more intermediate beams 7 spanning between the longitudinal beams 2, 2 at a predetermined interval; and the scaffolding plate 8 spanning between the longitudinal beams 2, 2 and supported by at least one of the intermediate beams 7, the number of scaffolding plates being one greater than the number of intermediate beams 7 installed.

According to this configuration, the number of scaffolding plates 8 installed in the frame 6 may be at least three or more, which makes it possible for the width of the scaffolding plate 8 to be narrower and to further reduce the weight per scaffolding plate 8 compared to when the number of scaffolding plates 8 installed in the frame 6 is two or fewer, as is conventional. Therefore, the work of assembling the scaffold device 1 is simplified and the time required for assembly of the scaffold device 1 may be shortened.

Moreover, since the width of the scaffolding plate 8 is narrower, the width between the intermediate beams 7, 7 supporting the scaffolding plate 8 is also narrower. Therefore, when assembling the scaffold device 1, the worker may perform the work of placing the next intermediate beam 7 and scaffolding plate 8 from above the scaffolding plate 8 spanning between the longitudinal beams 2, 2 to span between the longitudinal beams 2, 2 without leaning out far from above the scaffolding plate 8. Thus, the work of assembling the scaffold device 1 may be conducted in a safer manner.

Note that in the present embodiment, the number of intermediate beams 7 spanning between longitudinal beams 2, 2 is three and the number of scaffolding plates 8 supported by at least one intermediate beam 7 is four; however, if the number of intermediate beams 7 installed is two or more and the number of scaffolding plates 8 supported by at least one intermediate beam 7 is three or more, which is one greater than the number of intermediate beams 7 installed, the weight of each scaffolding plate 8 may be reduced more than which is conventional. Furthermore, if the number of intermediate beams 7 installed is two or more and the number of scaffolding plates 8 supported by at least one intermediate beam 7 is three or more, which is one greater than the number of intermediate beams 7 installed, the width between the intermediate beams 7, 7 supporting the scaffolding plates 8 will also be narrower; therefore, the work of assembling the scaffold device 1 may be conducted in a safer manner, as described above.

Furthermore, in the present embodiment, the coupling member 5 rotatably connects each end portion of the longitudinal beam 2 and each end portion of the transverse beam 3 in the horizontal direction; however, each end portion of the longitudinal beam 2 and each end portion of the transverse beam 3 may be rotatably connected in an upright direction. However, when the coupling member 5 rotatably connects each end portion of the longitudinal beam 2 and each end portion of the transverse beam 3 in the upright direction, it is necessary to ensure a distance from the scaffold device 1, that only allows rotation of the longitudinal beam 2 and the transverse beam 3 in the upright direction, to a building or structure, or even the ground; therefore, it is preferable that the coupling member 5 rotatably connects each end portion of the longitudinal beam 2 and each end portion of the transverse beam 3 in the horizontal direction.

Furthermore, in the scaffold device 1 of the present embodiment, the longitudinal beam 2 and the transverse beam 3 have the beam body 20 (30) and the respective connecting part 21 (31) that is detachably connected to both ends of the beam body 20 (30) in the lengthwise direction and is capable of connecting the beam body 20 (30) to the coupling member 5.

According to this configuration, when the beam body 20 (30) or the connecting part 21 (31) of the longitudinal beam 2 and the transverse beam 3 is damaged, only the damaged component needs to be detached and replaced, making maintenance of the scaffold device 1 simpler. Note that one beam body 20 (30) and connecting part 21 (31) of at least one of the longitudinal beam 2 and the transverse beam 3 need be connected detachably.

Furthermore, in the scaffold device 1 of the present embodiment, the beam body 20 (30) is formed of a material having a lower mass per unit volume than the connecting part 21 (31), and the connecting part 21 (31) is formed of a material having a higher rigidity than the beam body 20 (30).

According to this configuration, only the connecting part 21 (31), which is subject to a large shear load when the scaffold device 1 is in use, is formed of a highly rigid material, and the beam body 20 (30), which is subject to a smaller load than the connecting part 21 (31), is formed of a material having a lower mass per unit volume than the connecting part 21 (31); therefore, it is possible to reduce the weight of the longitudinal beam 2 or the transverse beam 3 while ensuring the rigidity of the scaffold device 1 and without reducing the load capacity. Thus, the foregoing configuration improves the assembly workability of the scaffold device 1.

Note that in the scaffold device 1 of the present embodiment, the beam body 20 (30) is made of steel and the connecting part 21 (31) is made of aluminum; however, as long as the beam body 20 (30) is formed of a material having a lower mass per unit volume than the connecting part 21 (31) and the connecting part 21 (31) is formed of a material having a higher rigidity than the beam body 20 (30), the materials of the beam body 20 (30) and the connecting part 21 (31) are not particularly limited. However, the beam body 20 (30) and the connecting part 21 (31) may be integrally formed of the same material.

Furthermore, in the scaffold device 1 of the present embodiment, the beam body 20 (30) has the upper chord member 22 (32) and the lower chord member 23 (33), which are disposed opposing at the top and bottom and mutually parallel; and at least one bundle member 24 (34) and plurality of the diagonal members 25 (35), which span between the upper chord member 22 (32) and the lower chord member 23 (33) and connect the upper chord member 22 (32) and the lower chord member 23 (33); wherein the upper chord member 22 (32), the lower chord member 23 (33), the bundle member 24 (34), and the diagonal member 25 (35) are mutually connected in a detachable form.

According to this configuration, even if a component constituting the beam body 20 (30) is damaged or deformed due to aging or a load, only the damaged or deformed component needs to be detached and replaced, making maintenance of the scaffold device 1 simple.

Furthermore, since the components constituting the beam body 20 (30) are connected in a detachable form, that is, by a method other than welding, when the beam body 20 (30) is made of aluminum, a metal that requires laborious welding, the beam body 20 (30) may be made into a truss structure while avoiding welding.

Furthermore, in the scaffold device 1 of the present embodiment, the upper chord member 22 (32) has the flat plate-shaped scaffolding plate support portion 22a (32a) extending along the beam body 20 (30) in the axial direction and supporting the scaffolding plate 8, and the pair of positioning pieces 22b, 22b (32b, 32b) standing upward from the upper surface side of the scaffolding plate support portion 22a (32a) and mutually opposing, and also restricting horizontal direction movement of the scaffolding plate 8 supported by the scaffolding plate support portion 22a (32a), wherein the bracket 11 to which the chain 9 may be attached as the suspension material for suspending the longitudinal beam 2 or the transverse beam 3 is connected between the positioning pieces 22b, 22b (32b, 32b) in the scaffolding plate support portion 22a, two scaffolding plates 8 are installed clamping the positioning pieces 22b, 22b with respect to the scaffolding plate support portion 22a, and the width of the bracket 11 is narrower than the width between the two scaffolding plates 8, 8.

According to this configuration, even if the bracket 11 is attached in advance to the longitudinal beam 2A or transverse beam 3A for expansion during the assembly of scaffold device 1, the bracket 11 will not constitute an obstruction when the scaffolding plate 8A for expansion spans between the longitudinal beam 2, 2 for expansion. Therefore, the lower end of the chain 9 may be attached to the bracket 11 immediately after all the scaffolding plates 8A for expansion are installed on the frame 6A for expansion, and the time during which the scaffolding unit μl for expansion is not suspended via the chain 9 attached to the bracket 11 may be shortened, thereby improving safety.

Furthermore, in the scaffold device 1 of the present embodiment, in a state where the first mounting holes 21d, 21d (31d, 31d) provided to the connecting part 21 (31) and the insertion holes 50a, 51a provided to the coupling member 5 are opposing, the fixing pins P1 inserted into the first mounting holes 21d, 21d (31d, 31d) and the insertion holes 50a, 51a cause the coupling member 5 to be rotatably connected to the longitudinal beam 2 or the transverse beam 3, and in a state where the second mounting holes 21e, 21e (31e, 31e) provided to the connecting part 21 (31) and the anti-rotation grooves 50b, 51b provided at the perimeter of the coupling member 5 are opposing, the anti-rotation pins P2 inserted into the second mounting holes 21e, 21e (31e, 31e) and the anti-rotation grooves 50b, 51b causes the coupling member 5 to be fixed to the longitudinal beam 2 or the transverse beam 3 in a non-rotatable state.

According to this configuration, when the transverse beam 3 spans between adjoining coupling members 5, 5 in the width direction, provided that at least one of the coupling members 5 is rotatably connected to the longitudinal beam 2 using only the fixing pin P1, one coupling member 5 may be rotated inward to bring the one coupling member 5 closer to the scaffolding plate 8 side. Therefore, when the worker places the transverse beam 3 to span between the coupling members 5, 5 from over the scaffolding plate 8, the extent to which the worker leans out from above the scaffolding plate 8 may be reduced, allowing the transverse beam 3 to be placed to span between the coupling members 5, 5 in a safer manner.

Moreover, when assembling the scaffold device 1, it may become difficult for the transverse beam 3 to span between the coupling members 5, 5 due to a dimensional error in each component constituting the scaffold device 1, misalignment of each component during assembly, or the like; however, in the present embodiment, by simply rotating outward one of the coupling members 5 in a state where one end of the transverse beam 3 is connected while rotated inward, it is possible to simply align the holes (first mounting hole 31d, first opposing hole 31g) of the connecting part 31 at the other end of the transverse beam 3 and the insertion holes 50a, 51a of the plates 50, 51 of the other coupling member 5.

Furthermore, in the scaffold device 1 of the present embodiment, the upper ends of the fixing pin P1 and the anti-rotation pin P2 are provided with two protrusions Pa, Pb in a vertical line that protrude through the fixing pin P1 and the anti-rotation pin P2 in the radial direction, and the two protrusions Pa, Pb are disposed facing a mutually intersecting direction when viewing from the axial direction of the fixing pin P1 and the anti-rotation pin P2.

According to this configuration, the upper side protrusion Pa functions as a handle for the fixing pin P1 and the anti-rotation pin P2, and the lower side protrusion Pb functions as a retainer for the fixing pin P1 and the anti-rotation pin P2.

Furthermore, supposing that the upper side protrusion Pa and the lower side protrusion Pb are disposed vertically and in parallel, if the thickness of the two holes is not ensured in the vertical direction at the upper end side of the fixing pin P1 and the anti-rotation pin P2 for connecting the upper side protrusion Pa and the lower side protrusion Pb to the fixing pin P1 and the anti-rotation pin P2, hole drilling will not be successful; therefore, it is necessary to leave an interval of a certain degree between the holes. In contrast, as in the present embodiment, when the upper side protrusion Pa and the lower side protrusion Pb are disposed in an intersecting direction when viewing from the axial direction of the fixing pin P1 and the anti-rotation pin P2, the two holes into which the upper side protrusion Pa and the lower side protrusion Pb are inserted are positioned at a twisted position; therefore, even if the distance between the two holes in the vertical direction is shortened, hole drilling may be carried out without difficulty.

Therefore, when the upper side protrusion Pa and the lower side protrusion Pb are disposed in an intersecting direction when viewing from the axial direction of the fixing pin P1 and the anti-rotation pin P2, the interval in the vertical direction between the upper side protrusion Pa and the lower side protrusion Pb may be made shorter than when the upper side protrusion Pa and the lower side protrusion Pb are disposed vertically and in parallel. Therefore, the fixing pin P1 and the anti-rotation pin P2 are inserted into the first mounting hole 21d (31d) and the second mounting hole 21e (31e), making it possible to reduce the protruding height of the upper ends of the fixing pin P1 and the anti-rotation pin P2 in a state where the lower side protrusion Pb is hooked on the edge of the first mounting hole 21d (31d) or the second mounting hole 21e (31).

Thus, when the upper side protrusion Pa and the lower side protrusion Pb are disposed in intersecting directions when viewing from the axial direction of the fixing pin P1 and the anti-rotation pin P2, the upper ends of the fixing pin P1 and the anti-rotation pin P2 do not protrude from the scaffolding plate 8, even when the thickness of the scaffolding plate 8 spanning between the longitudinal beams 2, 2 is reduced to reduce the weight of the scaffolding plate 8, preventing the worker from tripping over the fixing pin P1 and the anti-rotation pin P2. However, the upper side protrusion Pa and the lower side protrusion Pb may be disposed vertically and in parallel.

Furthermore, in the scaffold device 1 of the present embodiment, the coupling member 5 has the pair of upper and lower plates 50, 51 disposed in parallel, and a linking part 52 linking the plates 50, 51; the plates 50, 51 have four insertion holes 50a, 51a, which are respectively disposed at equal intervals on the same circumference and mutually opposing, and four anti-rotation grooves 50b, 51b provided on the perimeter of the plates 50, 51 and at a position directly facing the insertion holes 50a, 51a when viewed from the center of the plates 50, 51; the connecting part 21 (31) has the pair of upper and lower connecting pieces 21c, 21c (31c, 31c) protruding along the axial direction from each end portion of the beam body 20 (30); each connecting piece 21c (31c) has the respective mutually opposing first mounting hole 21d (31d) and the second mounting hole 21e, 21e disposed at a position opposing the anti-rotation grooves 50b, 51b in a state where the first mounting hole 21d (31d) is opposing at least one of the insertion holes 50a, 51a; and the anti-rotation groove 51b provided in the lower side plate 51 is formed shallower than the anti-rotation groove 50b provided in the upper side plate 50.

Here, since there is a slight gap between the fixing pin P1 inserted in the first mounting hole 21d (31d) and the insertion holes 50a, 51a, and the first mounting holes 21d, 21d (31d, 31d) and the insertion holes 50a, 51a, when the longitudinal beam 2 or the transverse beam 3 is connected to the coupling member 5, the fixing pin P1 tilts slightly in the first mounting holes 21d, 21d (31d, 31d) and the insertion holes 50a, 51a to the extent of the foregoing gap due to a moment incurred from the longitudinal beam 2 and transverse beam 3. Therefore, in a state where the coupling member 5 is connected to the longitudinal beam 2 and the transverse beam 3 using only the fixing pin P1, the longitudinal beam 2 and the transverse beam 3 tilt downward according to the inclination angle of the fixing pin P1.

On the other hand, there is also a slight gap between the anti-rotation pin P2 inserted in the second mounting hole 21e (31e) and the second mounting holes 21e, 21e (31e, 31e), and the lower side anti-rotation groove 51b provided in the lower side plate 51 is formed shallower than the upper side anti-rotation groove 50b provided in the upper side plate 50. Therefore, the anti-rotation pin P2 inserted into the second mounting holes 21e, 21e (31e, 31e) attempts to tilt in the second mounting holes 21e, 21e (31e, 31e) due to a moment incurred from the longitudinal beam 2 and the transverse beam 3; however, the lower end of the anti-rotation pin P2 is supported from a side by the lower side plate 51, and tilting is suppressed.

In other words, in the present embodiment, the lower end of the anti-rotation pin P2 is supported from the side by the lower side plate 51, even if it is subjected to a moment from the longitudinal beam 2 or the transverse beam 3; therefore, the longitudinal beam 2 or the transverse beam 3 may be disposed horizontally.

Furthermore, when the height of the coupling member 5 is lowered, the distance between the inner circumferences of the first mounting holes 21d, 21d, which serve as fulcrums to support the upper side and the lower side of the inclined fixing pin P1, also becomes closer; therefore, if the gap between the fixing pin P1 and the first mounting holes 21d, 21d (31d, 31d) and the insertion holes 50a, 51a is the same, the inclination angle of the fixing pin P1 becomes larger. Thus, when the height of the coupling member 5 is lowered, the downward inclination of the longitudinal beam 2 and the transverse beam 3 will also increase in a state where the coupling member 5 is connected to the longitudinal beam 2 and the transverse beam 3 using only the fixing pin P1. However, in the present embodiment, as described above, the lower end of the anti-rotation pin P2 is supported from the side by the lower side plate 51 and the longitudinal beam 2 and the transverse beam 3 are disposed horizontally even if subjected to a moment from the longitudinal beam 2 and the transverse beam 3; therefore, the foregoing problem does not occur even if the height of the coupling member 5 is lowered.

Thus, according to the present embodiment, the height of the coupling member 5 may be lowered and the coupling member 5 may be made lighter; therefore, the assembly workability of the scaffold device 1 may be further improved, and the time required for assembly of the scaffold device 1 may be further shortened.

However, when the downward inclination of the longitudinal beam 2 and the transverse beam 3 due to the inclination of the fixing pin P1 and the anti-rotation pin P2 is within an allowable range, a depth of the anti-rotation groove 50b in the upper side plate 50 and the anti-rotation groove 51b in the lower side plate 51 may be set to be the same.

Furthermore, although not illustrated, a respective auxiliary beam supporting each scaffolding plate 8 may span, parallel to the longitudinal beam 2, between the mutually opposing transverse beam 3 and the intermediate beam 7 and between the mutually opposing intermediate beams 7, 7. According to this configuration, bending of the scaffolding plate 8 may be prevented, and when installing the scaffolding plate 8, the scaffolding plate 8 may be prevented from falling from a frame surrounded by the pair of longitudinal beams 2, 2, the pair of transverse beams 3, 3, and each intermediate beam 7.

Furthermore, the method of assembling the scaffold device 1 of the present embodiment, wherein the scaffold device 1 is provided with a frame 6 having the pair of longitudinal beams 2, 2, the pair of transverse beams 3, 3, and four coupling members 5 disposed between each end portion of the longitudinal beam 2 and each end portion of the transverse beam 3 and rotatably connecting the longitudinal beam 2 and the transverse beam 3 on the same plane; two or more intermediate beams 7 spanning between the longitudinal beams 2, 2 at a predetermined interval; and a scaffolding plate 8 spanning between the longitudinal beams 2, 2 and supported by at least one of the intermediate beams 7, the number of scaffolding plates being one greater than the number of intermediate beams 7 installed; includes a step of respectively connecting the other ends of the pair of longitudinal beams 2A, 2A for expansion wherein the coupling member 5A for expansion is attached to one end to each coupling member 5 disposed on one side of the frame 6; a step of spanning the intermediate beam 7A for expansion between the pair of longitudinal beams 2A, 2A for expansion, repeating a step of spanning the scaffolding board 8A for expansion between the pair of longitudinal beams 2A, 2A for expansion while supported by at least the spanned intermediate beam 7A for expansion the same number of times as the number of intermediate beams 7A to be installed in one frame 6A, and spanning the transverse beam 3A for expansion between the coupling members 5A, 5A for expansion; and a step of spanning another scaffolding board 8A for expansion between the pair of longitudinal beams 2A, 2A for expansion while supported by at least the transverse beam 3A for expansion.

According to this configuration, the number of scaffolding plates 8 installed in the frame 6 may be at least three or more, which makes it possible for the width of the scaffolding plate 8 to be narrower and to further reduce the weight per scaffolding plate 8 compared to when the number of scaffolding plates 8 installed in the frame 6 is two or fewer, as is conventional. Therefore, the work of assembling the scaffold device 1 is simplified and the time required for assembly of the scaffold device may be shortened.

Furthermore, since the width of the scaffolding plate 8 is narrower, the width between the intermediate beams 7, 7 supporting the scaffolding plate 8 is also narrower. Therefore, the worker may place the next intermediate beam 7A for expansion and scaffolding plate 8A for expansion to span between the longitudinal beams 2A, 2A for expansion without leaning out far from above the existing scaffolding plate 8 or from above the scaffolding plate 8A for expansion spanning between the longitudinal beams 2A, 2A for expansion; therefore, the assembly work may be performed in a safer manner.

Moreover, according to the method of assembling the scaffold device 1, the step of connecting the end portions of the plurality of longitudinal beams 2 and the transverse beams 3 to the coupling member 5 is eliminated at once. Therefore, it is difficult to make an error in determining which of the insertion holes 50a, 51a from among the four insertion holes 50a, 51a provided in the coupling member 5 should be used to connect the longitudinal beam 2 and the transverse beam 3. Thus, according to the foregoing method of assembly, assembly errors are less likely to occur and assembly workability is improved.

Note that the number of times the step of spanning the intermediate beam 7A for expansion between the pair of longitudinal beams 2A, 2A for expansion and spanning the scaffolding plate 8A for expansion between the pair of longitudinal beams 2A, 2A for expansion while supported by at least the spanned intermediate beam 7A for expansion is repeated is the same as the number of intermediate beams 7 to be installed in the frame 6. Thus, when N (N is an integer of two or more) intermediate beams 7 are provided in one frame 6, the step is performed N times.

Continuing, a scaffold device 100 of a second embodiment will now be described in detail. Here, the parts of the scaffold device 100 of the second embodiment that differ from the scaffold device 1 of the first embodiment will be described in detail, and to avoid duplicate descriptions, the same members are marked with the same reference numerals and detailed descriptions have been omitted.

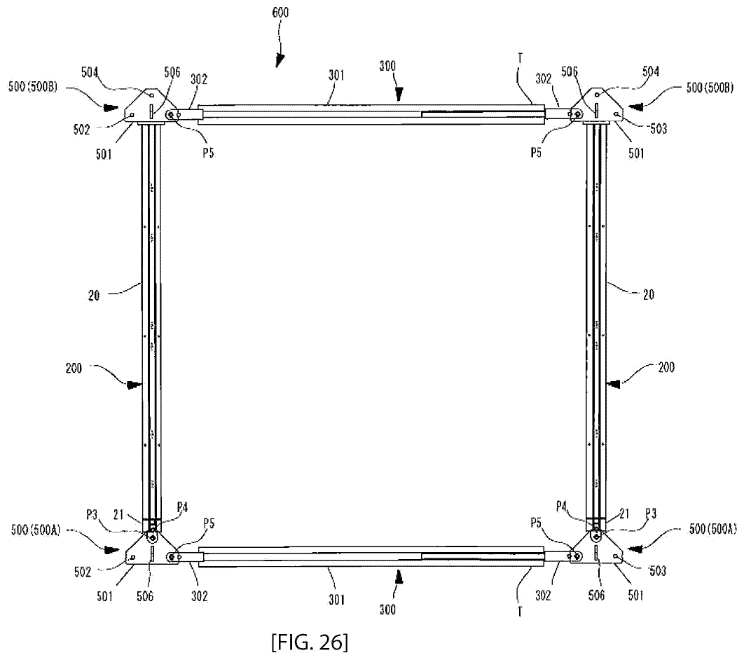

As illustrated in FIG. 26, the scaffold device 100 of the second embodiment is provided with a frame 600 having a pair of longitudinal beams 200, 200 disposed along a depth direction (vertical direction in the drawing), a pair of transverse beams 300, 300 disposed along a width direction (left to right direction in the drawing), and four coupling members 500 disposed between each end portion of the longitudinal beam 200 and each end portion of the transverse beam 300 and rotatably connecting the longitudinal beam 200 and the transverse beam 300 on the same plane; three intermediate beams 7 spanning between the longitudinal beams 200, 200 at a predetermined interval; and four scaffolding plates 8 spanning between the longitudinal beams 200, 200 and supported by at least one intermediate beam 7. Note that in FIG. 26, a description of the intermediate beam 7 and scaffolding plate 8 is omitted to simplify understanding of the structure of the frame 600. Furthermore, the intermediate beam 7 and the scaffolding plate 8 of the second embodiment are identical to the intermediate beam 7 and the scaffolding plate 8 in the scaffold device 1 of the first embodiment.

Hereafter, of the four coupling members 500, two coupling members 500 disposed at the front side (lower side in FIG. 26) in the depth direction of the frame 600 will be referred to as front-side coupling members 500A, and two coupling members 500 disposed at the back side (upper side in FIG. 26) in the depth direction of the frame 600 will be referred to as back-side coupling members 500B; the following is a description of each part of the scaffold device 100 of the second embodiment.

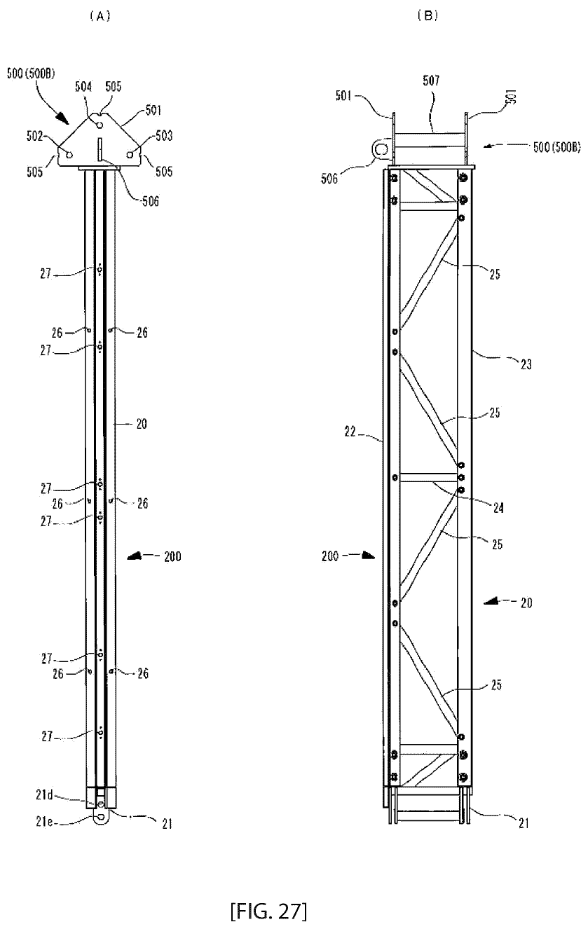

As illustrated in FIG. 27, the coupling member 500 of the present embodiment is provided with a pair of upper and lower plates 501, 501, and a cylinder-shaped linking part 507 linking the upper side plate 501 and the lower side plate 501. Furthermore, as illustrated in FIG. 26 and FIG. 27(A), each plate 501 is a flat plate shape formed by beveling the apex of an isosceles triangle, and the bottom side is fixedly connected to one end of the longitudinal beam 200 by welding. Thus, the front-side coupling member 500A is fixedly attached to one end of the longitudinal beam 200 of the frame 600 outside of the drawing disposed at the front side, and the back-side coupling member 500B is fixedly attached to one end of the longitudinal beam 200 of the frame 600 in the drawing. Note that the method of connecting the longitudinal beam 200 and the coupling member 500 is not limited to welding, as long as the longitudinal beam 200 and the coupling member 500 are integral and indivisible.

Furthermore, as illustrated in FIG. 27(A), a left hole 502 and a right hole 503, which are disposed in a line from left to right, and a front hole 504, which is disposed further to the back side than the left hole 502 and the right hole 503 (upper side in the drawing) and between the left hole 502 and the right hole 503, are formed in each plate 501. Note that the shape of the plate 501 is not particularly limited to the shape described above, and may be circular or rectangular.

Furthermore, as illustrated in FIG. 27(A), a respective anti-rotation groove 505 is provided on a perimeter of each plate 501 at positions directly facing the left hole 502, the right hole 503, and the front hole 504 when viewed from the center of each plate 501.

Moreover, as illustrated in FIG. 27, a center position of the upper side plate 501 surrounded by the left hole 502, the right hole 503, and the front hole 504 is provided with a chain bracket 506 to which a lower end of a chain 9 may be attached as a suspension material.

As illustrated in FIG. 26 and FIG. 27, the longitudinal beam 200 of the present embodiment differs from the longitudinal beam 2 of the first embodiment in that instead of a connecting part 21 provided at the back-side end of a beam body 20 (upper end in the drawing), the back-side coupling member 500B is integrally connected, and the other configurations are the same.

Specifically, as illustrated in FIG. 27, the longitudinal beam 200 of the present embodiment is provided with the beam body 20, and the connecting part 21 that is provided at the front-side end of the beam body 20 (lower end in the drawing) and capable of connecting to the front-side coupling member 500A. The connecting part 21 in the second embodiment corresponds to the first connecting part described in the scope of patent claims.

Furthermore, since the method is the same as the method of connecting the coupling member 5 to the end portion of the longitudinal beam 2 in the first embodiment, it is not illustrated in detail; however, in the present embodiment, in a state where the front hole 504 of the front-side coupling member 500A and a first mounting hole 21d provided to the connecting part 21 are opposed, a first linking pin P3 is inserted, causing the longitudinal beam 200 to connect rotatably in the horizontal direction to the front-side coupling member 500A, and in a state where the anti-rotation groove 505 directly facing the front hole 504 of the front-side coupling member 500A and a second mounting hole 21e provided to the connecting part 21 are opposed, an anti-rotation pin P4 is inserted, causing the longitudinal beam 200 to be fixed in a non-rotatable state to the front-side coupling member 500A attached fixedly to the longitudinal beam 200 of the frame 600 at the front outside of the drawing.

Note that the configuration of the first linking pin P3 and the anti-rotation pin P4 of the present embodiment is the same structure as the fixing pin P1 and the anti-rotation pin P2 in the first embodiment, but may also be different.

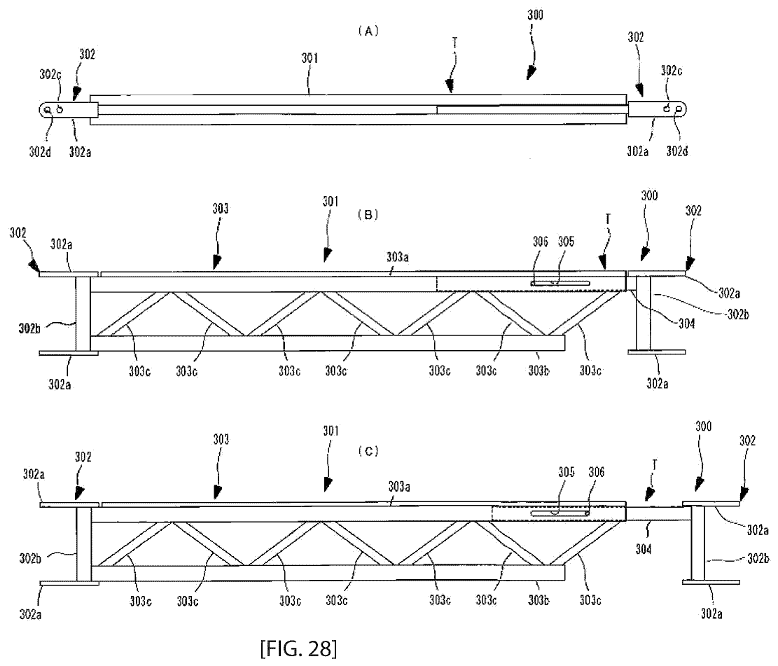

As illustrated in FIG. 26 and FIG. 28, the transverse beam 300 of the present embodiment is provided with a beam body 301 having a telescope part T constituted by an upper chord member 303a as an outer cylinder and a sliding body 404 as an inner cylinder slidably inserted into the upper chord member 303a, and a second connecting part 302 provided at both ends of the beam body 301 in a lengthwise direction and that is capable of connecting to the coupling member 500.

Specifically, as illustrated in FIG. 28(B), the beam body 301 of the present embodiment is provided with the upper chord member 303a and a lower chord member 303b having a square cylindrical-shaped cross section, which are disposed vertically opposing and mutually parallel; a support body 303 configured as a truss structure, having a plurality of a diagonal member 303c, which spans diagonally between the upper chord member 303a and the lower chord member 303b and connects the upper chord member 303a and the lower chord member 303b; and a sliding body 304 having a rectangular cylindrical-shaped cross section as the inner cylinder slidably inserted into the upper chord member 301a as the outer cylinder.

In other words, in the present embodiment, the telescope part T is constituted by the upper chord member 301a and the sliding body 304 that is slidably inserted into the upper chord member 301a, and as illustrated in FIGS. 28(B) and (C), moving the sliding body 304 in and out of the upper chord member 301a makes it possible to telescope the telescope part T and change an axial direction length of the transverse beam 300.

Note that in the present embodiment, the upper chord member 303a of the support body 303 is used as the outer cylinder of the telescope part T; however, the lower chord member 303b may also be used as the outer cylinder of the telescope part T. Alternatively, both the upper chord member 303a and the lower chord member 303b may be used as the outer cylinder of the telescope part T, two inner cylinders inserted into each outer cylinder may be provided, and these inner cylinders may be used as the inner cylinder of the telescope part T. However, when the number of inner cylinders of the telescope part T is made to be two, the strength of the telescope part T improves but the weight of the transverse beam 300 increases to the extent of the increased number of inner cylinders of the telescope part T. Note that the number of outer cylinders and inner cylinders of the telescope part T may be designed and changed according to the required strength and weight.

Furthermore, in the transverse beam 300 of the present embodiment, the telescope part T is provided at one end side of the beam body 301; however, the telescope part T may be provided halfway down the beam body 301 in the axial direction.

Note that in the present embodiment, the support body 303 has a truss structure to ensure the strength of the beam body 301; however, the structure of the support body 303 is not limited to a truss structure provided that the necessary strength is assured.

Furthermore, the telescope part T of the present embodiment is provided with fall prevention means to prevent the sliding body 304 from falling out of the upper chord member 303a. Specifically, as illustrated in FIGS. 28(B) and (C), the fall prevention means of the present embodiment is provided with a long hole 305 formed along the upper chord member 303a in the axial direction as the outer cylinder of the telescope part T, and a restriction pin 306 protruding in a radial direction from the perimeter of the sliding body 304 and inserted into the long hole 305. The restriction pin 306 restricts further contraction of the telescope part T when contacting an edge of the upper chord member 303a on a center side (left side in the drawing) in the long hole 305, as illustrated in FIG. 28(B), and restricts further extension of the telescope part T when contacting the edge of the upper chord member 303a on a tip side (right side in the drawing) in the long hole 305, as illustrated in FIG. 28(C).

Therefore, when providing this kind of fall prevention means, it is possible to set a telescopeable length of the telescope part T and also prevent the sliding body 304 from falling out from the upper chord member 303a during transportation of the transverse beam 300.

Note that the configuration of the fall prevention means described above is one example, and is not limited to the means described above provided that it is possible to prevent the sliding body 304 from falling out from the upper chord member 303a. Thus, for example, the upper chord member 303a as the outer cylinder and the sliding body 304 as the inner cylinder may respectively be provided with pin holes capable of mutually opposing when the telescope part T contracts, and a lock pin may be inserted into both pin holes to prevent the sliding body 304 from falling out. When this is the case, if the lock pin is inserted into both pin holes only during transportation of the transverse beam 300, the telescope part T does not telescope on its own during transportation of the transverse beam 300, and the telescope part T does not obstruct the transportation of the transverse beam 300.

Returning, as illustrated in FIG. 28, the second connecting part 302 of the present embodiment is provided with a pair of upper and lower opposing plates 302a, 302a, and a cylinder-shaped linking body 302b linking the base ends of the pair of opposing plates 302a, 302a. Furthermore, each opposing plate 302a is provided with a first hole 302c disposed on a base end side, and a second hole 302d disposed on the tip side, in a line along the beam body 301 of the transverse beam 300 in the lengthwise direction.

Furthermore, as illustrated in FIG. 28, the respective linking body 302b of the second connecting part 302 is fixed to a sliding body side end opposite to the support body 303 (left end in FIG. 28(B)) and the sliding body side end opposite to the sliding body 304 (right end in FIG. 28(B)), respectively, so that both ends of the beam body 301 are provided with the second connecting part 302.

Also, in a state where the first hole 302c of each second connecting part 302 is opposing a right hole 503 of the coupling member 500 on the left side and a left hole 502 of the coupling member 500 on the right side, respectively, of the two connecting parts 500, 500 opposing in a width direction of the frame 600, a second linking pin P5 is inserted into the left hole 502 and the right hole 503 and the first hole 302c of each second connecting part 302, causing the transverse beam 300 to be connected rotatably in the horizontal direction to the opposing coupling members 500, 500 in the width direction of the frame 600. Note that the structure of the second linking pin P5 of the present embodiment is the same structure as the fixing pin P1 of the first embodiment, but may also be different.

Furthermore, the structure and the number of the intermediate beam 7 and the scaffolding plate 8, which span between the longitudinal beams 200, 200, are the same as in the first embodiment and therefore descriptions have been omitted.

Continuing, the method of assembling the scaffold device 100 of the second embodiment will be described in detail. Here, the frame 600 and the intermediate beam 7 and the scaffolding plate 8 which span between the longitudinal beams 200, 200 of the frame 600 are described as one scaffolding unit A10.

First, similar to the first embodiment, the scaffold device 100 is assembled on the ground, wherein a plurality of the scaffolding units A10 is linked in the depth direction and the width direction. Also, the scaffold device 100 assembled on the ground is then suspended from a building or structure via the chain 9 that is not illustrated.

Next, in a state where the first mounting hole 21d of the connecting part 21 of each longitudinal beam 200 opposes each front hole 504 of the front-side coupling member 500A, which is the coupling member 500 connected to a back-side end of the longitudinal beam 200 in the scaffolding unit A10 of the scaffold device 100 suspended from a building or structure (hereinafter referred to as an “existing scaffolding unit”), a respective first linking pin P3 is inserted into the first mounting hole 21d and the front hole 504 and each longitudinal beam 200 is connected rotatably in the horizontal direction to each front-side coupling member 500A.

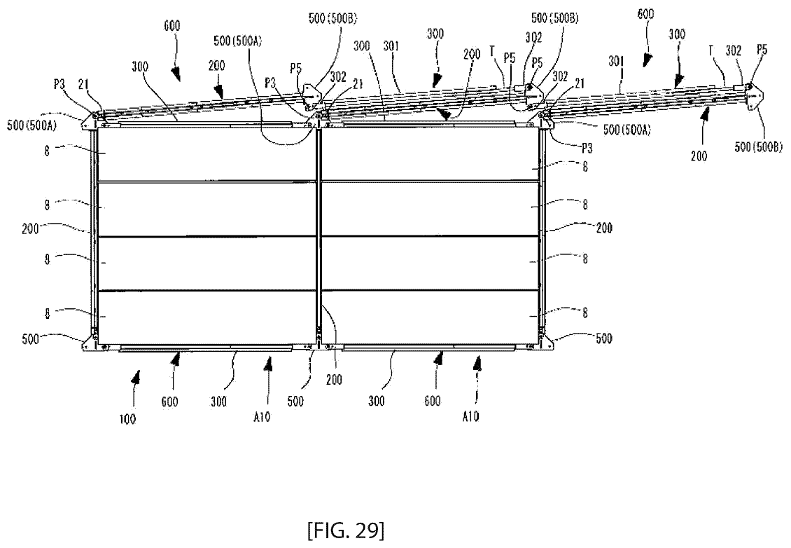

Thereafter, as illustrated in FIG. 29, in a state where the back-side end of each longitudinal beam 200 is pulled toward its respective front side, and the first hole 302c of the second connecting part 302 of the respective transverse beam 300 is opposing the right hole 503 of the back-side coupling member 500B positioned at the left side and the left hole 502 of the back-side coupling member 500B positioned at the right side among the adjoining back-side coupling members 500B in the width direction, the respective second linking pin P5 is inserted into the left hole 502, the right hole 503, and the first hole 302c of the second connecting part 302 and each end portion of the transverse beam 300 is connected rotatably in the horizontal direction to each back-side coupling member 500B, 500B. In this way, a plurality of the frames 600 is linked to the front-side coupling member 500A in a folded position, as illustrated in FIG. 29.

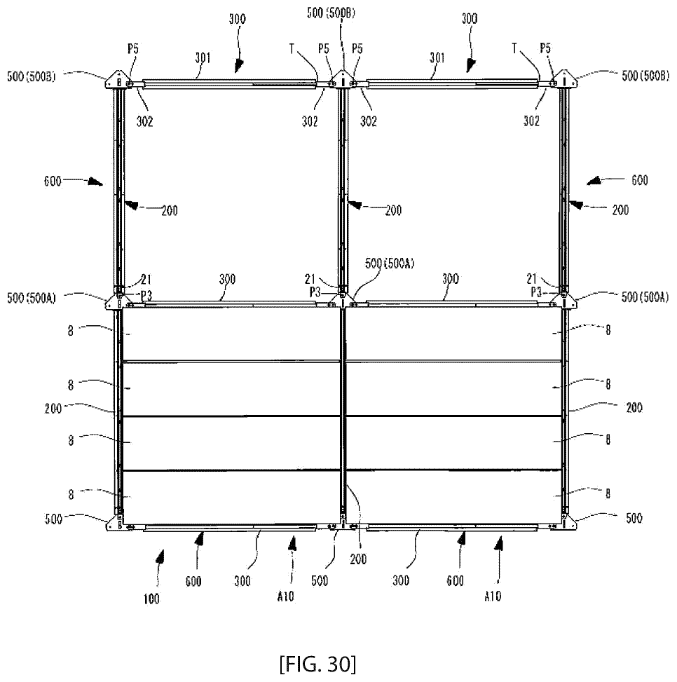

Next, as illustrated in FIG. 30, each longitudinal beam 200 is rotated in the horizontal direction with respect to the front-side coupling member 500A until the longitudinal beams 200 and the transverse beams 300 are disposed mutually parallel, changing the plurality of the frames 600 from a folded position to an unfolded position.

Here, the distance between the adjoining back-side coupling members 500B, 500B in the width direction of the frame 600 is closest when the frame 600 is in the unfolded position and farthest when the frame 600 is in the folded position; however, in the present embodiment, the transverse beam 300 is provided with the telescope part T, and therefore, the telescope part T achieves maximum extension when the frame 600 is in the folded position, as illustrated in FIG. 29, and the telescope part T achieves maximum contraction when the frame 600 is in the unfolded position, as illustrated in FIG. 30. In other words, a change in the distance between the adjoining back-side coupling members 500B, 500B in the width direction of the frame 600 may be handled by telescoping the telescope part T to change an axial direction length of the transverse beam 300.

Thus, according to the scaffold device 100 of the present embodiment, even if the back-side coupling member 500B is integrally connected to the back-side end of the longitudinal beam 200, after linking the plurality of the frames 600 to the front-side coupling member 500A in a folded position, the position of the plurality of the frames 600 is changed to the unfolded position to allow the plurality of the frames 600 to be assembled at once.

Thereafter, the anti-rotation pin P4 is inserted into the second mounting hole 21e of the connecting part 21 provided at the front-side end of each longitudinal beam 200, and each longitudinal beam 200 is fixed in a non-rotatable state to the front-side coupling member 500A.

Note that in the second embodiment, the back-side coupling member 500B is integrally connected to the back-side end of the longitudinal beam 200; therefore, when the longitudinal beam 200 is fixed in a non-rotatable state to the front-side coupling member 500A, the transverse beam 300 also automatically enters a non-rotatable state with respect to the back-side coupling member 500B. Therefore, the second embodiment does not require an anti-rotation pin to connect the transverse beam 300 to the back-side coupling member 500B in a non-rotatable state.

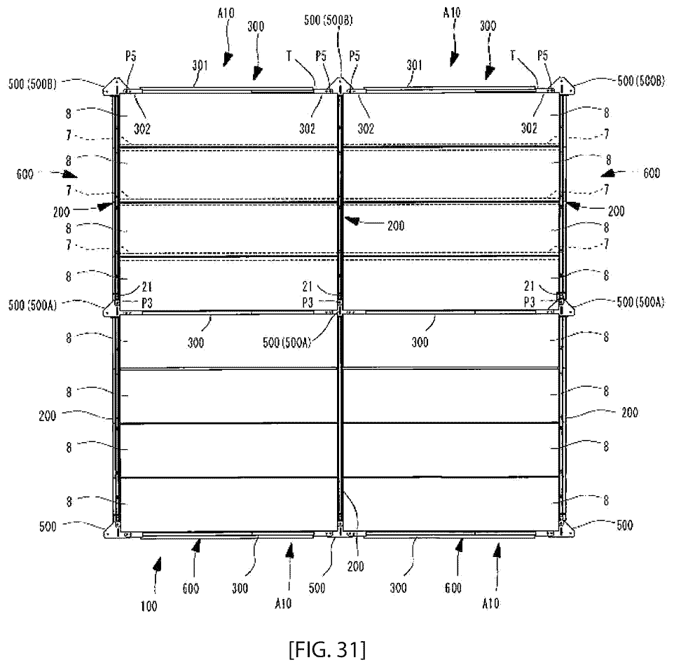

Finally, a step of spanning the intermediate beams 7 between the adjoining longitudinal beams 200, 200 in the width direction of the frame 600 in order from the front side in the depth direction and a step of spanning the scaffolding plates 8 between the longitudinal beams 200, 200 while supported by the transverse beam 300 and the intermediate beam 7 or by the intermediate beams 7, 7 adjoining in the depth direction are repeated the same number of times as the number of intermediate beams 7 to be installed in one frame 600. This allows the scaffolding unit A10 for expansion to be connected to the existing scaffolding unit A10 of the scaffold device 100, as illustrated in FIG. 31.

Repeating the foregoing procedure in the width direction or the depth direction makes it possible to expand the floorboard area of the scaffold device 100 of the present embodiment to any desired position in a state where suspended from a building or structure.

However, the method of assembling the scaffold device 100 is not limited to the method described above; as with the scaffold device 1 of the first embodiment, the method may include disposing the pair of longitudinal beams 200 parallel along the depth direction, and then repeating a step of spanning the intermediate beam 7 between the longitudinal beams 200, 200 and spanning the scaffolding plate 8 between the longitudinal beams 200, 200 while supported by at least the spanned intermediate beam 7 the same number of times as the number of intermediate beams 7 to be installed in one frame 600 in order from the front side, spanning the transverse beam 300 to a depth-side end of the longitudinal beam 200, and finally spanning the scaffolding plate 8 between the longitudinal beams 200, 200 while supported by the transverse beam 300 on the back side.

As described above, in the scaffold device 100 of the present embodiment, the left hole 502 and the right hole 503, which are disposed in a line from left to right, and the front hole 504 disposed further to the back side than the left hole 502 and the right hole 503 are formed in the coupling member 500; the back-side coupling member 500B is integrally connected to the back-side end of the longitudinal beam 200, and the front-side end thereof is provided with the connecting part 21 (first connecting part) having a hole (first mounting hole 21d); the transverse beam 300 has the beam body 301 having the telescope part T constituted by the outer cylinder (upper chord member 301a) and the inner cylinder (sliding body 304) slidably inserted into the outer cylinder (upper chord member 301a), and the second connecting part 302 provided at both ends of the beam body 301 in the lengthwise direction and having respective holes (first hole 302c); in a state where the hole (first mounting hole 21d) of the connecting part 21 and the front hole 504 of the front-side coupling member 500A are opposing, the first linking pin P3 inserted into the hole (first mounting hole 21d) of the connecting part 21 and the front hole 504 of the front-side coupling member 500A rotatably connects the transverse beam 200 in the horizontal direction to the front-side mounting member 500A; and in a state where the hole (first hole 302c) of each respective second connecting part 302 is opposing, among the two back-side connecting parts 500B opposing in the width direction of the frame 600, the right hole 503 of the back-side connecting part 500B on the left side and the left hole 502 of the back-side connecting part 500B on the right side, the respective second linking pin P5 inserted into the left hole 502, the right hole 503, and the hole (first hole 302c) of each second connecting part 302 rotatably connects each end portion of the transverse beam 300 in the horizontal direction to each back-side coupling member 500B.

According to this configuration, the back-side coupling member 500B is integrally connected to the back-side end of the longitudinal beam 200, eliminating the need for the worker to perform the work of connecting the back-side coupling member 500B to each longitudinal beam 200 when assembling the scaffold device 100. Therefore, the work of assembling the scaffold device 100 is simplified and the time required for assembly of the scaffold device 100 may be shortened.

Moreover, in the scaffold device 100 of the present embodiment, the transverse beam 300 is provided with the telescope part T. Therefore, according to the scaffold device 100 of the present embodiment, even if the back-side coupling member 500B is integrally connected to the back-side end of the longitudinal beam 200, when the position of the frame 600 is changed from the folded position to the unfolded position, a change in the distance between the adjoining back-side coupling members 500B, 500B in the width direction of the frame 600 may be handled by telescoping the telescope part T to change the axial direction length of the transverse beam 300. Thus, in the present embodiment, the plurality of the frames 600 may be assembled at once according to the above-described method wherein after linking the plurality of the frames 600 to the front-side coupling member 500A in a folded position, the position of the plurality of the frames 600 is changed to the unfolded position.

Furthermore, in the scaffold device 100 of the present embodiment, similar to the scaffold device 1 of the first embodiment, the number of intermediate beams 7 spanned between the longitudinal beams 200, 200 is two or more, and the number of scaffolding plates 8 installed in the frame 600 is at least three or more, which makes it possible for the width of the scaffolding plate 8 to be narrower and to further reduce the weight per scaffolding plate 8 compared to when the number of scaffolding plates 8 installed in the frame 600 is two or fewer, as is conventional.

Moreover, since the width of the scaffolding plate 8 is narrower, the width between the intermediate beams 7, 7 supporting the scaffolding plate 8 is also narrower. Therefore, when assembling the scaffold device 100, the worker may perform the work of placing the next intermediate beam 7 and scaffolding plate 8 from above the scaffolding plate 8 spanning between the longitudinal beams 200, 200 to span between the longitudinal beams 200, 200 without leaning out far from above the scaffolding plate 8. Thus, the work of assembling the scaffold device 100 may be conducted in a safer manner.

However, in the scaffold device 100 of the second embodiment, the number of intermediate beams 7 installed may be less than two, and the number of scaffolding plates 8 installed in the frame 600 may be two or less.

Continuing, a first variation in the scaffold device 100 of the second embodiment will be described below. Here, the parts of a scaffold device 100A of the first variation that differ from the scaffold device 100 of the second embodiment will be described in detail, and to avoid duplicate descriptions, the same members are marked with the same reference numerals and detailed descriptions have been omitted.

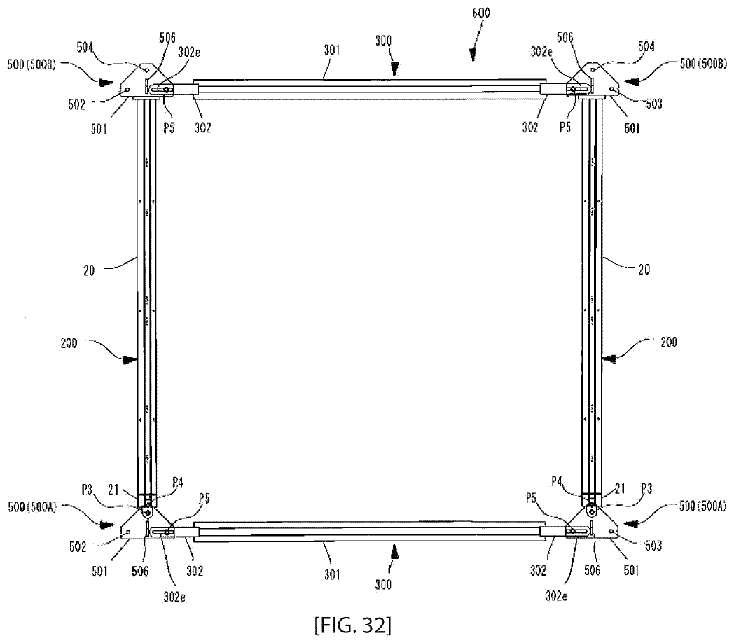

As illustrated in FIG. 32, the scaffold device 100A of the first variation differs from the second embodiment in that the telescope part T provided in the transverse beam 300 is omitted, and instead of the first hole 302c and the second hole 302d of the second connecting part 302 provided at both ends of the transverse beam 300 in the lengthwise direction, a long hole 302e of a long length in the direction along the axial direction of the transverse beam 300 is provided. Note that in FIG. 32, a description of the intermediate beam 7 and scaffolding plate 8 is omitted to simplify understanding of the structure of the frame 600 of the scaffold device 100A of the first variation.

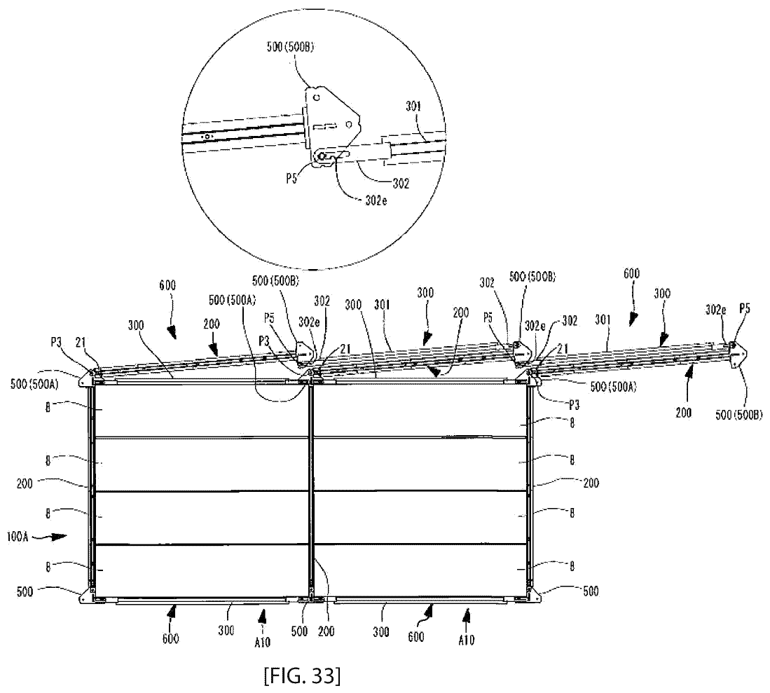

In the scaffold device 100A of the first variation, as illustrated in FIG. 33, in a state where the frame 600 is in the folded position and the distance between the adjoining back-side coupling members 500B, 500B in the width direction of the frame 600 is farthest, each second linking pin P5 connecting each end portion of the transverse beam 300 and each back-side coupling member 500B contacts a tip edge of each long hole 302e.

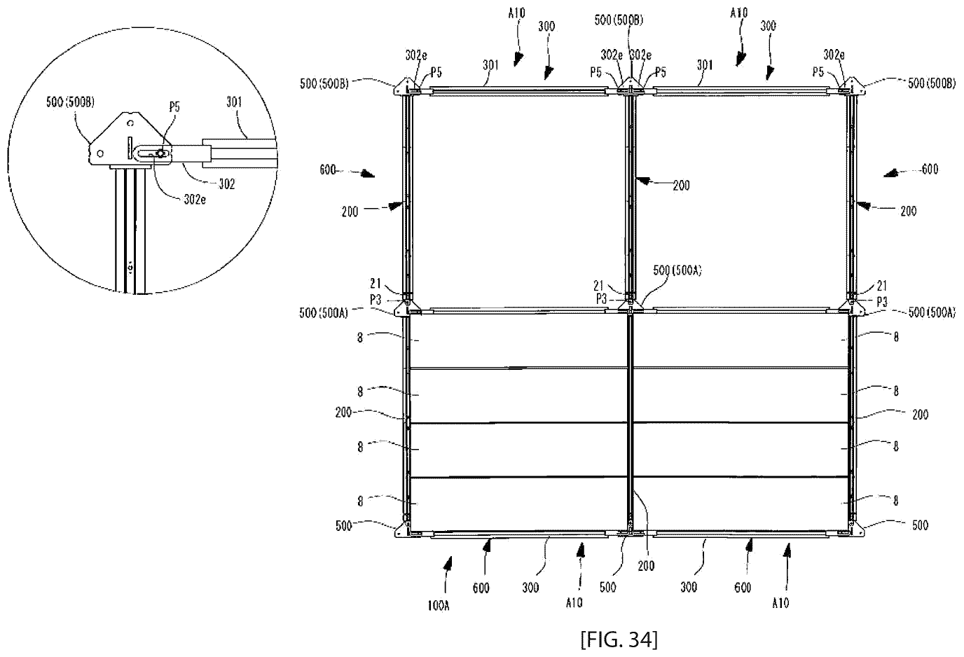

Also, as illustrated in FIG. 34, in a state where the frame 600 is in the unfolded position and the distance between the adjoining back-side coupling members 500B, 500B in the width direction of the frame 600 is closest, each second linking pin P5 connecting each end portion of the transverse beam 300 to each back-side coupling member 500B is positioned near a base end edge of each long hole 302e.

Therefore, in the scaffold device 100A of the first variation, when the position of the frame 600 is changed from the folded position to the unfolded position, a change in the distance between the adjoining back-side coupling members 500B, 500B in the width direction of the frame 600 may be handled by sliding each second linking pin P5 along the lengthwise direction of each long hole 302e.

Thus, in the scaffold device 100A of the first variation, even if the back-side coupling member 500B is integrally connected to the back-side end of the longitudinal beam 200, the plurality of the frames 600 may be assembled at once according to the method wherein after linking the plurality of the frames 600 to the front-side coupling member 500A in a folded position, the position of the plurality of the frames 600 is changed to the unfolded position.

Note that in the first variation, the length of the long hole 302e is set so that each second linking pin P5 contacts the tip edge of each long hole 302e when the frame 600 is in the folded position, and each second linking pin P5 is positioned closer to the base end edge of each long hole 302e when the frame 600 is in the unfolded position; however, the long hole 302e should be set to a length that allows movement of the second linking pin P5 at least when changing the position of the frame 600 from the folded position to the unfolded position.

Furthermore, in the scaffold device 100A of the first variation, similar to the scaffold device 100 of the second embodiment, the back-side coupling member 500B is integrally connected to the back-side end of the longitudinal beam 200, eliminating the need for the worker to perform the work of connecting the back-side coupling member 500B to each longitudinal beam 200 when assembling the scaffold device 100. Therefore, the work of assembling the scaffold device 100A is simplified and the time required for assembly of the scaffold device 100A may be shortened.

Continuing, a second variation in the scaffold device 100 of the second embodiment will be described below. Here, the parts of a scaffold device 100B of the second variation that differ from the scaffold device 100 of the second embodiment will be described in detail, and to avoid duplicate descriptions, the same members are marked with the same reference numerals and detailed descriptions have been omitted.

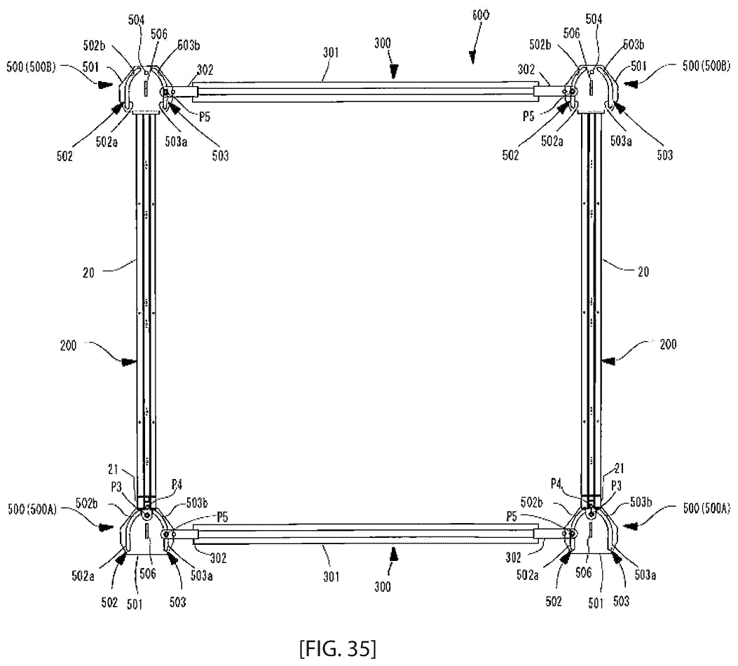

As illustrated in FIG. 35, the scaffold device 100B of the second variation differs from the second embodiment in that the telescope part T provided in the transverse beam 300 is omitted and the left hole 502 and the right hole 503 formed in the coupling member 500 have straight portions 502a, 503a, respectively, along the depth direction, and curved portions 502b, 503b that stretch to the back-side end of the straight portions 502a, 503a and curve mutually inward. Note that in FIG. 35, a description of the intermediate beam 7 and scaffolding plate 8 is omitted to simplify understanding of the structure of the frame 600 of the scaffold device 100B of the second variation.

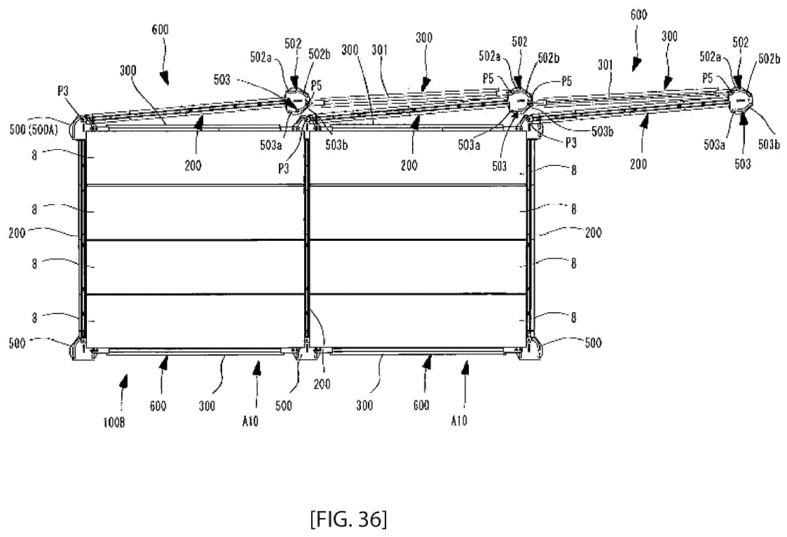

In the scaffold device 100B of the second variation, as illustrated in FIG. 36, in a state where the frame 600 is in the folded position wherein the longitudinal beam 200 is folded on the right side in the drawing and the distance between the adjoining back-side coupling members 500B, 500B in the width direction of the frame 600 is farthest, the second linking pin P5 connecting the back-side coupling member 500B on the left side in the drawing to the left end of the transverse beam 300 is positioned at the back-side end in the curved portion 503b of the right hole 503 in the back-side coupling member 500B on the left side, and the second linking pin P5 connecting the back-side coupling member 500B on the left side of the drawing to the right end of the transverse beam 300 is positioned at the front-side end in the straight portion 502a of the left hole 502 in the back-side coupling member 500B on the right side.

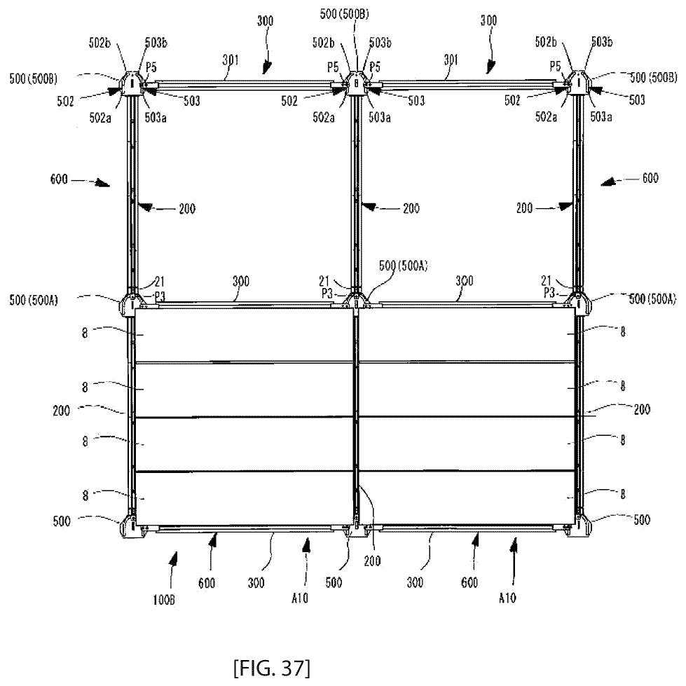

Note that as illustrated, the frame 600 is shown in a folded position, folded to the right side, but the frame 600 may be folded to the left side. In such a case, the second linking pin P5 connecting the back-side coupling member 500B on the left side in the drawing to the left end of the transverse beam 300 is positioned at the front-side end in the straight portion 503a of the right hole 503 in the back-side coupling member 500B on the left side, and the second linking pin P5 connecting the back-side coupling member 500B on the right side in the drawing to the right end of the transverse beam 300 is positioned at the back-side end in the curved portion 502b of the left hole 502 in the back-side coupling member 500B on the right side. Also, as illustrated in FIG. 37, in a state where the frame 600 is in the unfolded position and the distance between the adjoining backside coupling members 500B, 500B in the width direction of the frame 600 is closest, the respective second linking pin P5 connecting each end portion of the transverse beam 300 to the left and right backside coupling members 500B, 500B is positioned in the straight portion 503a of the right hole 503 in the back-side coupling member 500B on the left side in the drawing, and in the straight portion 502a of the left hole 502 in the back-side coupling member 500B on the right side in the drawing, respectively.

Thus, in the scaffold device 100B of the second variation, the right hole 503 of the back-side coupling member 500B on the left side and the left hole 502 of the back-side coupling member 500B on the right side are shaped to follow a movement path of the second linking pin P5 when the position of the frame 600 is changed from the folded position to the unfolded position.

Therefore, when the position of the frame 600 is changed from the folded position to the unfolded position, even if the distance between the adjoining back-side coupling members 500B, 500B in the width direction of the frame 600 changes, each second linking pin P5 handles the change by sliding within the right hole 503 of the back-side coupling member 500B on the left side and the left hole 502 of the back-side coupling member 500B on the right side to change position in accordance with the change in distance between the back-side coupling members 500B, 500B.

Thus, in the scaffold device 100B of the second variation, even if the back-side coupling member 500B is integrally connected to the back-side end of the longitudinal beam 200, the plurality of the frames 600 may be assembled at once according to the method wherein after linking the plurality of the frames 600 to the front-side coupling member 500A in a folded position, the position of the plurality of the frames 600 is changed to the unfolded position.

Furthermore, in the scaffold device 100B of the second variation, similar to the scaffold device 100 of the second embodiment, the back-side coupling member 500B is integrally connected to the back-side end of the longitudinal beam 200, eliminating the need for the worker to perform the work of connecting the back-side coupling member 500B to each longitudinal beam 200 when assembling the scaffold device 100. Therefore, the work of assembling the scaffold device 100B is simplified and the time required for assembly of the scaffold device 100B may be shortened.

The above is a detailed description of preferred embodiments of the present invention; however, it is natural that modifications, variations, and changes may be made without departing from the scope of the patent claims.

### DESCRIPTION OF REFERENCE NUMERALS

1, 100, 100A, 100B . . . Scaffold device,
2, 200 . . . Longitudinal beam,
3, 300 . . . Transverse beam,
5, 500, 500A, 500B . . . Coupling member,
6, 600 . . . Frame,
7 . . . Intermediate beam,
8 . . . Scaffolding plate,
9 . . . Chain (suspension material),
11 . . . Bracket,
20, 30, 301 . . . Beam body,
21, 31 . . . Connecting part (first connecting part),
21c, 31c . . . Connecting piece,
21d, 31d . . . First mounting hole (hole),
21e, 31e . . . Second mounting hole,
22, 32 . . . Upper chord member,
22a, 32a . . . Scaffolding plate support portion,
22b, 32b . . . Positioning piece,
23, 33 . . . Lower chord member,
24, 34 . . . Bundle member,
25, 35 . . . Diagonal member,
50 . . . Upper side plate,
51 . . . Lower side plate,
50a, 51a . . . Insertion hole,
50b, 51b . . . Anti-rotation groove,
52 . . . Linking part,
301a . . . Upper chord member (outer cylinder),
302 . . . Second connecting part,
302c . . . First hole (hole),
302e . . . Long hole (hole),
304 . . . Sliding body (inner cylinder),
502 . . . Left hole,
503 . . . Right hole,
502a, 503a . . . Straight portion,
502b, 503b . . . Curved portion,
504 . . . Front hole,
P1 . . . Fixing pin,
P2, P4 . . . Anti-rotation pin,
P3 . . . First linking pin,
P5 . . . Second linking pin,
Pa . . . Upper side protrusion,
Pb . . . Lower side protrusion,
T . . . Telescope part

1. A scaffold device, comprising: a frame having a pair of longitudinal beams, a pair of transverse beams, and four coupling members disposed between each end portion of the longitudinal beam and each end portion of the transverse beam and rotatably connecting the longitudinal beam and the transverse beam on the same plane;
two or more intermediate beams spanned between the longitudinal beams at a predetermined interval; and
a scaffolding plate spanning between the longitudinal beams and supported by at least one of the intermediate beams, the number of scaffolding plates being one greater than the number of intermediate beams installed.

2. The scaffold device according to claim 1, wherein:
the longitudinal beam and the transverse beam have a beam body, and a respective connecting part connected detachably to both ends of the beam body in a lengthwise direction and capable of connecting the beam body to the coupling member.

3. The scaffold device according to claim 2, wherein:
the beam body is formed of a material having a lower mass per unit volume than the connecting part; and
the connecting part is formed of a material having a higher rigidity than the beam body.

4. The scaffold device according to claim 2 or 3, wherein:
the beam body comprises an upper chord member and a lower chord member, which are disposed opposing at the top and bottom and mutually parallel, and at least one bundle member and a plurality of a diagonal member, which span between the upper chord member and the lower chord member and connect the upper chord member to the lower chord member; and
the upper chord member, the lower chord member, the bundle member, and the diagonal member are mutually connected in a detachable form.

5. The scaffold device according to claim 4, wherein:
the upper chord member comprises a flat plate-shaped scaffolding plate support portion extending along the beam body in an axial direction and supporting the scaffolding plate, and a pair of positioning pieces standing upward from an upper surface side of the scaffolding plate support portion and mutually opposing, and also having a pair of positioning pieces restricting horizontal direction movement of the scaffolding plate supported by the scaffolding plate support portion;
a bracket to which a suspension material for suspending the longitudinal beam or the transverse beam may be attached is connected between the positioning pieces in the scaffolding plate support portion;
two scaffolding plates are placed clamping the positioning pieces with respect to the scaffolding plate support portion; and
a width of the bracket is narrower than the width between the two scaffolding plates.

6. The scaffold device according to any one of claims 2 to 5, wherein:
in a state where a first mounting hole provided to the connecting part and an insertion hole provided to the coupling member are opposing, a fixing pin inserted into the first mounting hole and the insertion hole causes the coupling member to be rotatably connected to the longitudinal beam or the transverse beam; and
in a state where a second mounting hole provided to the connecting part and an anti-rotation groove provided at a perimeter of the coupling member are opposing, an anti-rotation pin inserted into the second mounting hole and the anti-rotation groove causes the coupling member to be fixed to the longitudinal beam or the transverse beam in a non-rotatable state.

7. The scaffold device according to claim 6, wherein:
an upper end of the fixing pin and the anti-rotation pin is provided with two protrusions in a vertical line, protruding in a radial direction; and
the two protrusions are disposed toward a mutually intersecting direction when viewing the fixed pin and the anti-rotation pin from the axial direction.

8. The scaffold device according to claim 6 or 7, wherein:
the coupling member comprises a pair of upper and lower plates disposed in parallel, and a linking part linking the plates;
the plates comprise four insertion holes, which are respectively disposed at an equal interval on the same circumference and mutually opposing, and four anti-rotation grooves provided on a perimeter of the plates and at a position directly facing the insertion holes when viewed from the center of the plates;
the connecting part comprises a pair of upper and lower connecting pieces protruding along the axial direction from each end portion of the beam body;
each connecting piece comprises the respective mutually opposing first mounting holes, and the second mounting hole disposed at a position opposing the anti-rotation groove in a state where the first mounting hole is opposing at least one of the insertion holes; and
the anti-rotation groove provided in the plate of a lower side is formed shallower than the anti-rotation groove provided in the plate of an upper side.

9. The scaffold device according to any one of claims 1 to 8, further comprising:
an auxiliary beam supporting the scaffolding plate, spanning parallel to the respective longitudinal beam between the mutually opposing transverse beam and the intermediate beam and between the mutually opposing intermediate beams.

10. The scaffold device according to claim 1, wherein:
among the coupling members, two coupling members disposed at a front side in a depth direction of the frame are designated as front-side coupling members, and two coupling members disposed at a back side in the depth direction of the frame are designated as back-side coupling members;
the coupling member has a left hole and a right hole, which are disposed in a line from left to right, and a front hole disposed further to the back side than the left hole and the right hole formed therein;
the back-side coupling member is integrally connected to the back-side end of the longitudinal beam, and the front-side end thereof is provided with a first connecting part having a hole;
the transverse beam comprises a beam body having a telescope part constituted by an outer cylinder and an inner cylinder slidably inserted into the outer cylinder, and a second connecting part provided at both ends of the beam body in a lengthwise direction and having a respective hole thereat;
in a state where the hole of the first connecting part and the front hole of the front-side coupling member are opposing, a first linking pin inserted into the hole of the connecting part and the front hole of the front-side coupling member rotatably connects the transverse beam in the horizontal direction to the front-side coupling member; and
in a state where the respective hole of each second connecting part is opposing, among the two back-side coupling members opposing in the width direction of the frame, the right hole of the back-side coupling member on a left side and the left hole of the back-side coupling member on a right side, a respective second linking pin inserted into the left hole, the right hole, and the hole of each second connecting part rotatably connects each end portion of the transverse beam in the horizontal direction to each back-side coupling member.

11. The scaffold device according to claim 1, wherein:
among the coupling members, two coupling members disposed at a front side in a depth direction of the frame are designated as front-side coupling members, and two of the coupling members disposed at a back side in the depth direction of the frame are designated as back-side coupling members;
the coupling member has a left hole and a right hole, which are disposed in a line from left to right, and a front hole disposed further to the back side than the left hole and the right hole formed therein;
the back-side coupling member is integrally connected to the back-side end of the longitudinal beam, and the front-side end thereof is provided with a first connecting part having a hole;
both ends of the transverse beam in a lengthwise direction are provided with a second connecting part having a hole of a long length in a direction along the respective transverse beam in the axial direction;
in a state where the hole of the first connecting part and the front hole of the front-side coupling member are opposing, a first linking pin inserted into the hole of the first connecting part and the front hole of the front-side coupling member rotatably connects the longitudinal beam in the horizontal direction to the front-side coupling member;
in a state where the respective hole of each second connecting part is opposing, among the two back-side coupling members opposing in the width direction of the frame, the right hole of the back-side coupling member on a left side and the left hole of the back-side coupling member on a right side, a respective second linking pin inserted into the left hole, the right hole, and the hole of each second connecting part rotatably connects each end portion of the transverse beam in the horizontal direction to each back-side coupling member; and
the second linking pin is slidable along the hole of the second connecting part in the lengthwise direction.

12. The scaffold device according to claim 1, wherein:
among the coupling members, two of the coupling members disposed at a front side in a depth direction of the frame are designated as front-side coupling members, and two of the coupling members disposed at a back side in the depth direction of the frame are designated as back-side coupling members;
the coupling member has a left hole and a right hole, which are disposed in a line from left to right, and a front hole disposed further to the back side than the left hole and the right hole formed therein;
the left hole and the right hole, respectively, comprise a straight portion along the depth direction, and a curved portion stretching to the back-side end of the straight portion and curved mutually inward;
the back-side coupling member is integrally connected to the back-side end of the longitudinal beam, and the front-side end thereof is provided with a first connecting part having a hole;
both ends of the transverse beam in the lengthwise direction are provided with the second connecting part having a respective hole;
in a state where the hole of the first connecting part and the front hole of the front-side coupling member are opposing, a first linking pin inserted into the hole of the first connecting part and the front hole of the front-side coupling member rotatably connects the longitudinal beam in the horizontal direction to the front-side coupling member; and
in a state where the respective hole of each second connecting part is opposing, among the two back-side coupling members opposing in the width direction of the frame, the right hole of the back-side coupling member on a left side and the left hole of the back-side coupling member on a right side, a respective second linking pin inserted into the left hole, the right hole, and the hole of each second connecting part rotatably connects each end portion of the transverse beam in the horizontal direction to each back-side coupling member.

13. A method of assembling a scaffold device, the scaffold device provided with:
a frame having a pair of longitudinal beams, a pair of transverse beams, and four coupling members disposed between each end portion of the longitudinal beam and each end portion of the transverse beam and rotatably connecting the longitudinal beam and the transverse beam on the same plane;
two or more intermediate beams spanning between the longitudinal beams at a predetermined interval; and
a scaffolding plate spanning between the longitudinal beams and supported by at least one of the intermediate beams, the number of scaffolding plates being one greater than the number of intermediate beams installed; wherein:
the method of assembling the scaffold device comprises:
a step of respectively connecting an other end of a pair of longitudinal beams for expansion to which a coupling member for expansion is attached to one end to each coupling member disposed on one side of the frame;
a step of spanning an intermediate beam for expansion between the pair of longitudinal beams for expansion, repeating a step of spanning a scaffolding board for expansion between the pair of longitudinal beams for expansion while supported by at least the spanned intermediate beam for expansion the same number of times as the number of intermediate beams to be installed in one frame, and spanning a transverse beam for expansion between the coupling members for expansion; and
a step of spanning another scaffolding plate for expansion between the longitudinal beams for expansion while supported by at least the transverse beam for expansion.

14. The method of assembling a scaffold device according to any one of claims 10 to 12, wherein the method of assembling a scaffold device comprises:
a step of, in a state where the hole of the first connecting part of each longitudinal beam and the front hole of each front-side coupling member are opposing, inserting the respective first linking pin into the hole of each first connecting part and the front hole of each front-side coupling member to rotatably connect each longitudinal beam in a horizontal direction to each front-side coupling member;
a step of pulling the back-side end of the pair of longitudinal beams toward the respective front sides, causing the respective hole of each second connecting part of the transverse beam to oppose the right hole of the back-side coupling member on the left side and the left hole of the back-side coupling member on the right side, and inserting the respective second linking pin into the left hole, the right hole, and the hole of each second connecting part to connect each end portion of the transverse beam in the horizontal direction to each back-side coupling member; and
a step of rotating the pair of longitudinal beams in the horizontal direction toward the front-side coupling member, causing the longitudinal beams and the transverse beams to be disposed in parallel.
